(19) United States
(12) Patent Application Publication
(10) Pub. No.: US 2025/0094223 A1
(43) Pub. Date: Mar. 20, 2025

(54) METHOD AND SYSTEM FOR PERFORMING GENERATIVE ARTIFICIAL INTELLIGENCE AND FINE TUNING THE DATA MODEL

(71) Applicant: Oracle International Corporation, Redwood Shores, CA (US)

(72) Inventors: Ming Fang, Bellevue, WA (US); Simo Lin, Bellevue, WA (US); Jinguo Zhang, Bellevue, WA (US); Wei Gao, Bellevue, WA (US)

(73) Assignee: Oracle International Corporation, Redwood Shores, CA (US)

(21) Appl. No.: 18/676,248

(22) Filed: May 28, 2024

Related U.S. Application Data
(60) Provisional application No. 63/583,167, filed on Sep. 15, 2023.
(60) Provisional application No. 63/583,169, filed on Sep. 15, 2023.

(51) Int. Cl. G06F 9/50; H04L 9/08

(52) U.S. Cl. CPC G06F 9/5011; H04L 9/0825; G06F 2209/503

(57) ABSTRACT

A system and computer-implemented method include receiving a request for allocating graphical processing unit (GPU) resources for performing an operation. The request includes metadata identifying a client identifier (ID) associated with a client, throughput, and latency of the operation. A resource limit is determined for performing the operation based on the metadata. Attributes associated with each GPU resource of a plurality of GPU resources available for assignment are obtained. The attribute is analyzed that is associated with each GPU resource with respect to the resource limit. A set of GPU resources is identified from the plurality of GPU resources based on the analysis. A dedicated AI cluster is generated by patching the set of GPU resources within a single cluster. The dedicated AI cluster reserves a portion of a computation capacity of a computing system for a period of time and the dedicated AI cluster is allocated to the client associated with the client ID.

### CROSS REFERENCE TO RELATED APPLICATIONS

This application claims the benefits of priority to U.S. Provisional Application No. 63/583,167, filed on Sep. 15, 2023, entitled “Secure Gen-AI Platform Integration on a Cloud Service”, and to U.S. Provisional Application No. 63/583,169, filed on Sep. 15, 2023, entitled “Method and system for performing generative artificial intelligence and fine tuning the data model”. Each of these applications is hereby incorporated by reference in its entirety for all purposes.

### BACKGROUND

Generative Artificial Intelligence (AI) is based on one or more models and/or algorithms that are configured to generated new content, such as new text, images, music, or videos. Frequently, Generative AI models receive complex prompts (e.g., in a natural language format, an audio/video file, an image, etc.) and generate a complex output. Each input prompt and/or each output may be represented in a high-dimensional space that may include one or more dimensionalities representing time, individual pixels, frequencies, higher dimensional features, etc. Often times, prompt processing is complex, as it can be important to assess a given portion of the input query in view of another portion of the input query. Further, while many older machine-learning models may generate an output as simple as a score or classification, outputs from Generative AI models are typically more complex and of a larger data size. To handle all of the prompt and output complexity, many Generative AI models have millions or even billions of parameters. Thus, there is a need to efficiently configure powerful computing resources to train and deploy Generative AI models.

### SUMMARY

In an embodiment, a computer-implemented method includes receiving a request for allocating graphical processing unit (GPU) resources for performing an operation. The request includes metadata identifying a client identifier (ID) associated with a client, throughput, and latency of the operation. A resource limit is determined for performing the operation based on the metadata. Further, attributes associated with each GPU resource of multiple GPU resources available for assignment are obtained. The attributes indicate a capacity of a corresponding GPU resource. The attribute is analyzed with respect to the resource limit. A set of GPUs is identified from the multiple GPU resources based on the analysis. A dedicated AI cluster is generated by grouping a set of GPUs into a single cluster. The dedicated AI cluster reserves a portion of a computation capacity of a computing system for a period of time and the dedicated AI cluster is allocated to the client associated with the client ID.

Prior to allocation of the dedicated AI cluster, the request is authenticated based on the client ID associated with the client. The request is authenticated using a private key extracted from an asymmetric key pair associated with the client ID. In addition, a pre-approved quota associated with the request may be acquired. If the pre-approved quota exceeds a pre-defined request limit corresponding to the client ID, the request may be blocked. If the pre-approved quota is within the pre-defined request limit, the request may be forwarded for further processing. Further, a type of operation may be determined based on the request. The set of GPU resources is selected from one of a single node or multiple nodes, to generate the dedicated AI cluster. For example, if the request is related to fine-tuning of a data model, the set of GPU resources are selected from the single node to form the dedicated AI cluster. In such a case, a data model to be fine-tuned is obtained and a fine-tuning logic is executed on the data model using the dedicated AI cluster.

In another embodiment, a computer-implemented method includes monitoring a set of performance parameters corresponding to each graphical processing unit (GPU) resource of a first set of GPU resources included in a dedicated AI cluster. The set of performance parameters includes at least one of a physical condition or a logical condition of a corresponding GPU resource. The set of performance parameters is compared with a pre-defined set of performance parameters. Based on the comparison, an anomaly is determined in a first GPU resource of the first set of GPU resources. The anomaly indicates a deviation in the set of performance parameters from the pre-defined set of performance parameters. Further, a second GPU resource is identified from a second set of GPU resources in response to the anomaly determined in the first GPU resource. The second GPU resource is identified by matching a computation capacity of the second GPU resource with a computation capacity of each GPU resource of the first set of GPU resources. The second set of GPU resources are reserved for replacement. When the second GPU resource is detected, the first GPU resource is released from the dedicated AI cluster and the second GPU resource is patched into the dedicated AI cluster.

The physical condition of each GPU includes a temperature of corresponding GPU resource, a clock cycle of each core associated with the corresponding GPU resource, an internal memory of the corresponding GPU resource, and a power supply of the corresponding GPU resource. The logical condition of each GPU includes a failure of a plugin associated with corresponding GPU resource, a startup issue associated with the corresponding GPU resource, a runtime failure, and a security breach. The anomaly in the first GPU is determined using a rotation hash value. The rotation hash value is calculated based on a computation image, a computation shape, and resources of each GPU resource of the second set of GPU resources. The rotation hash value indicates security and compliance status of corresponding GPU resource. The patching of the second GPU resource to the dedicated AI cluster is terminated based on a pre-defined condition. The pre-defined condition is a failure of the second GPU resource during launch, a failure of the second GPU resource to join the dedicated AI cluster, a workload failure of the second GPU resource, and a software bug detected in the second GPU resource. A tag with the second set of GPU resources is associated in response to a determination of the pre-defined condition. The tag indicates unsuitability in patching of the second set of GPU resources.

In another embodiment, a computer-implemented method includes monitoring a computation capacity of each graphical processing unit (GPU) resource of a set of GPU resources reserved for a client. Based on the computation capacity, first GPU resources are identified from the set of GPU resources that are utilized for performing an operation associated with the client. Further, attributes of the operation are determined based on an analysis of an input and an output of the operation. A dummy operation is generated using the attributes of the operation performed on the first GPU resources and the dummy operation is executed on second GPU resources of the set of GPU resources that are unutilized for performing the operation.

During execution of the dummy operation on the second GPU resources, a request may be received from the client to access the second GPU resources for performing an actual operation. When the request to access the one or more second GPU resources is received, the dummy operation from the one or more second GPUs is terminated, and the actual operation is executed using the second GPU resources.

In some embodiments, a computer-implemented method is provided that comprises: receiving a request for allocating graphical processing unit (GPU) resources for performing an operation, wherein the request includes metadata identifying a client identifier (ID) associated with a client, a target throughput and a target latency of the operation; determining a resource limit for performing the operation based on the metadata; obtaining at least one attribute associated with each GPU resource of a plurality of GPU resources available for assignment in a computing system, wherein the at least one attribute indicates capacity of a corresponding GPU resource; analyzing the at least one attribute associated with each GPU resource with respect to the resource limit; identifying a set of GPU resources from the plurality of GPU resources based on the analysis; generating a dedicated AI cluster by patching the set of GPU resources within a single cluster, wherein the dedicated AI cluster reserves a portion of a computation capacity of the computing system for a period of time; and allocating the dedicated AI cluster to the client associated with the client ID.

A disclosed method may comprise: authenticating, prior to the allocation of the dedicated AI cluster, the request based on the client ID associated with the client, wherein the request is authenticated using a private key extracted from an asymmetric key pair associated with the client ID.

A disclosed method may comprise: comparing a set of performance parameters corresponding to each GPU resource of the set of GPU resources with a pre-defined set of performance parameters; determining an anomaly in a first GPU resource of the set of GPU resources based on the comparison, wherein the anomaly indicates a deviation in the set of performance parameters from the pre-defined set of performance parameters; and replacing the first GPU resource with a second GPU resource within the dedicated AI cluster, wherein a hash value of the second GPU resource is the same as a hash value of the first GPU resource.

A disclosed method may comprise: determining a pre-approved quota associated with the request; determining whether the pre-approved quota exceeds a pre-defined request limit corresponding to the client ID; and blocking the request based on the determination that the pre-approved quota exceeds the pre-defined request limit.

A disclosed method may comprise: determining a type of the operation based on the request; and selecting, based on the type of the operation, the set of GPU resources from one of a single node or multiple nodes, to generate the dedicated AI cluster. Based on determining that the request indicates a fine-tuning operation: a data model to be fine-tuned may be obtained; and a fine-tuning logic may be executed on the data model using the dedicated AI cluster, wherein the dedicated AI cluster is generated using the set of GPU resources selected from the single node.

A disclosed method may comprise: identifying at least one GPU resource, from the set of GPU resources of the dedicated AI cluster, that is underutilized; and executing, in response to the identification of the at least one GPU resource, a dummy operation on the at least one GPU resource, wherein the dummy operation is exactly the same as the operation performed on the at least one GPU resource.

In some embodiments, a computer-implemented method is provided that comprises: monitoring a set of performance parameters corresponding to each graphical processing unit (GPU) resource of a first set of GPU resources included in a dedicated AI cluster, wherein the set of performance parameters includes at least one of a physical condition or a logical condition of a corresponding GPU resource; comparing the set of performance parameters corresponding to each GPU resource with a pre-defined set of performance parameters; determining an anomaly in a first GPU resource of the first set of GPU resources based on the comparison, wherein the anomaly indicates a deviation in the set of performance parameters from the pre-defined set of performance parameters; identifying, in response to the anomaly determined in the first GPU resource, a second GPU resource from a second set of GPU resources by matching a computation capacity of the second GPU resource with a computation capacity of each GPU resource of the first set of GPU resources, wherein the second set of GPU resources are reserved for replacement; releasing the first GPU resource from the dedicated AI cluster; and patching the second GPU resource to the dedicated AI cluster.

The physical condition of each GPU resource may comprise at least one of a temperature of corresponding GPU resource, a clock cycle of each core associated with the corresponding GPU resource, an internal memory of the corresponding GPU resource, and a power supply of the corresponding GPU resource; and the logical condition of each GPU resource may comprise at least one of a failure of a plugin associated with corresponding GPU resource, a startup issue associated with the corresponding GPU resource, a runtime failure, and a security breach.

A disclosed method may comprise: calculating a rotation hash value for each GPU resource of the second set of GPU resources based on at least one of a computation image, a computation shape, and resources of each GPU resource of the second set of GPU resources; comparing the rotation hash value of each GPU resource of the second set of GPU resources with a rotation hash value of the dedicated AI cluster; and identifying the second GPU resource based on the comparison. The rotation hash value may indicate security and compliance status of corresponding GPU resource.

A disclosed method may comprise terminating the patching of the second GPU resource to the dedicated AI cluster based on a pre-defined condition, wherein the pre-defined condition is one of: a failure of the second GPU resource during launch; a failure of the second GPU resource to join the dedicated AI cluster; a workload failure of the second GPU resource; and a software bug detected in the second GPU resource.

A disclosed method may comprise associating, in response to a determination of the pre-defined condition, a tag with the second set of GPU resources, wherein the tag indicates unsuitability in patching of the second set of GPU resources.

Each GPU resource of the second set of GPU resources may be configured to continuously perform a dummy operation that is exactly the same as an actual operation performed by each GPU resource of the first set of GPU resources.

In some embodiments, a computer-implemented method is provided that comprises: monitoring a computation capacity of each graphical processing unit (GPU) resource of a set of GPU resources reserved for a client; identifying, based on the computation capacity, one or more first GPU resources from the set of GPU resources that are utilized for performing an operation associated with the client; determining attributes of the operation based on an analysis of an input and an output of the operation; generating a dummy operation using the attributes of the operation performed on the one or more first GPU resources; and executing the dummy operation on one or more second GPU resources of the set of GPU resources that are unutilized for performing the operation.

A disclosed method may comprise: receiving a request to access the one or more second GPU resources for performing the operation; terminating, in response to the request to access the one or more second GPU resources, the dummy operation from the one or more second GPU resources; and executing the operation using the one or more second GPU resources.

A disclosed method may comprise: determining an anomaly in a first GPU resource of the one or more first GPU resources based on a deviation in a set of performance parameters of the first GPU resource from a pre-defined set of performance parameters; identifying, in response to the anomaly determined in the first GPU resource, a second GPU resource from the one or more second GPU resources by matching a computation capacity of the second GPU resource with a computation capacity of each GPU resource of the one or more first GPU resources; and executing the operation on the second GPU resource.

The set of performance parameters may include at least one of a physical condition or a logical condition of a corresponding GPU resource.

The physical condition of each GPU resource may comprise at least one of a temperature of corresponding GPU resource, a clock cycle of each core associated with the corresponding GPU resource, an internal memory of the corresponding GPU resource, and a power supply of the corresponding GPU resource; and the logical condition of each GPU resource may comprise at least one of a failure of a plugin associated with corresponding GPU resource, a startup issue associated with the corresponding GPU resource, a runtime failure, and a security breach.

A disclosed method may comprise: determining a pre-approved quota associated with a request received from the client; determining whether the pre-approved quota exceeds a pre-defined request limit corresponding to the client; and blocking the request based on the determination that the pre-approved quota exceeds the pre-defined request limit.

A disclosed method may comprise: authenticating the request using a private key extracted from an asymmetric key pair associated with the client.

In various aspects, a system is provided that includes one or more data processors and a non-transitory computer readable storage medium containing instructions which, when executed on the one or more data processors, cause the one or more data processors to perform part or all of one or more methods disclosed herein.

In various aspects, a computer-program product is provided that is tangibly embodied in a non-transitory machine-readable storage medium and that includes instructions configured to cause one or more data processors to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure is described in conjunction with the appended figures:

FIG. 1 illustrates a block diagram of a system for providing and supporting a generative Artificial Intelligence (AI) platform, according to an exemplary embodiment.

FIG. 2 illustrates an exemplary architecture of a data plane of the generative AI platform, according to an exemplary embodiment.

FIG. 3 illustrates a block diagram of API server, according to an exemplary embodiment.

FIG. 4 illustrates a data flow diagram of the rate limiter, according to an exemplary embodiment.

FIG. 5 illustrates a block diagram of the metering worker, according to an exemplary embodiment.

FIG. 6 illustrates a high-level design diagram for creation of a dedicated AI cluster (DAC), according to an exemplary embodiment.

FIG. 7 illustrates a block diagram of a system configured for creating dedicated AI, according to an exemplary embodiment.

FIG. 8 illustrates a flow diagram of a control plane request being propagated to a management plane and then a data plane of a generative AI platform, according to an exemplary embodiment.

FIGS. 9A and 9B illustrate a sequence diagram of the process of creation of DACs, according to an exemplary embodiment.

FIG. 10 illustrates a flow diagram indicating the working of DAC operator, according to an exemplary embodiment.

FIG. 11 illustrates a flow diagram of the process of model operator, according to an exemplary embodiment.

FIG. 12 illustrates a sequence diagram of the process of creating base model and fine-tuned model resources, according to an exemplary embodiment.

FIG. 13 illustrates a sequence diagram of a method of fine tuning a base AI model, according to an exemplary embodiment.

FIG. 14 illustrates a data flow diagram for fine-tuning of a data model, according to an exemplary embodiment.

FIGS. 15A and 15B illustrate a sequence diagram of the process of creation of DACs, according to an exemplary embodiment.

FIG. 16 illustrates a data flow diagram for managing a fine-tuned inference server using the endpoint operator, according to an exemplary embodiment.

FIG. 17 illustrates a sequence diagram of a logical process within the inference server, according to an exemplary embodiment.

FIG. 18 illustrates a data flow diagram indicating the working of a model endpoint operator, according to an exemplary embodiment.

FIG. 19 illustrates a sequence diagram for creating a base inference service, creating a fine-tuned inference service, and deleting the fine-tuning inference service, according to an exemplary embodiment.

FIG. 20 illustrates a flowchart of a process for allocating a dedicated AI cluster, according to an exemplary embodiment.

FIG. 21 illustrates a flowchart of a process of fault management, according to an exemplary embodiment.

FIG. 22 illustrates a flowchart of a process for managing execution of operations using the GPU resources, according to an exemplary embodiment.

### DETAILED DESCRIPTION

In the following description, for the purposes of explanation, specific details are set forth to provide a thorough understanding of certain embodiments. However, it will be apparent that various embodiments may be practiced without these specific details. The figures and description are not intended to be restrictive. The word “exemplary” is used herein to mean “serving as an example, instance, or illustration”. Any embodiment or design described herein as “exemplary” is not necessarily to be construed as preferred or advantageous over other embodiments or designs.

As described above, Generative AI models typically are very large and require immense computational resources for training and deployment. This is even more so true, given that many deployments of such models are in environments where users expect nearly immediate outputs responsive to prompts.

CPUs, while versatile and capable of handling various tasks, lack the parallel processing power that can efficiently train and deploy such large and sophisticated Generative AI models. In contrast, GPUs (Graphics Processing Units) excel at parallel computation. These hardware accelerators significantly speed up the training and inference processes, enabling faster experimentation, deployment, and real-time applications of generative AI across diverse domains.

However, GPU usage presents several challenges. For example, GPUs, especially high-end models optimized for deep learning tasks, can be expensive to purchase and maintain. Additionally, GPUs are power-hungry devices, consuming significant amounts of electricity during training and inference. This can lead to high operational costs, especially for large-scale deployments where multiple GPUs are used simultaneously. Thus, efficiently using GPU resources is a priority. However, some entities prioritize ensuring reliable and quick availability of GPUs and GPU processing, so as to support providing real-time or near real-time responses to prompts. Cloud providers that serve requests from multiple entities therefore have competing priorities of using GPUs most efficiently and to also ensure that GPU processing is performed in a manner such that assurance of GPU availability can be provided.

Certain aspects and features of the present disclosure relate to a technique for allocating dedicated GPU resources to individual clients. Routing of task requests is then performed in a manner such that any dedicated GPU resource is preserved solely for the client to which the GPU resource is allocated. This may result in a GPU resource being idle for a period of time, if a client's tasks are of sufficient quantity or complexity to fully consume the GPU resource. However, any such GPU resource assigned to the client may then be assigned to be a back-up GPU and to perform a dummy operation for a given task that duplicates the operation being performed by another GPU resource assigned to the client. Performance variables of each GPU resource may be monitored, and a predefined condition can be evaluated based on one or more performance variables. For example, latency of ping responses and/or operation completion can be monitored and compared to a corresponding threshold. When it is determined that the predefined condition is not satisfied, the back-up GPU may be assigned to handle the given task. Instead of then needing to initiate full performance of the task from that point forward, the prior initiation of the dummy operation can be used to generate and/or return a result relatively timely.

In an example, a client may request for training or fine-tuning of a data model implemented on a computing system. Such an operation may contain complex computation and may require a substantial amount of throughput and latency. The request is received from a client through a client system. Each client and/or each client system is associated with a unique client identity (ID). The request includes a metadata that identifies the client ID.

The computing system identifies a set of GPU resources available for assignment from the total GPU resources of the computing system. The set of GPU resources are then combined together to form a single cluster. The cluster is further assigned to the client and/or the client system associated with the client. The assignment is performed using the client ID associated with the client and/or the client system. Such a cluster is also referred to as a dedicated AI cluster. The dedicated AI cluster reserves a portion of the computation capacity of the computing system for a period of time requested by the client.

Once the dedicated AI cluster is assigned to the client and/or the client system associated with the client, the operation requested by the client starts performing using the GPU resources patched into the dedicated AI cluster. Assigning the dedicated AI cluster to the client ensures that workloads associated with the operation requested by the client are not mixed and matched with workload associated with an operation requested by another client. As a result, the computing system is able to provide the computation capacity for the operation which requires massive computational capacity, such as training or fine-tuning of the data model.

In some embodiments, the GPU resources may suffer from outages and/or failures during execution of the operation. Such failures may correspond to a plugin failure, a provision failure, and/or a response failure. In the plugin failure, a GPU resource is not able to start up properly. In the provision failure, a GPU resource failed to provision at the time of execution of the operation. In the response failure, a GPU resource failed to response at runtime. Certain aspects and features of the present disclosure provide a technique to overcome the above-mentioned scenarios. The computing system monitors a set of performance parameters corresponding to each GPU resource of the set of GPU resources included in the dedicated AI cluster. The set of performance parameters includes a physical condition and/or a logical condition of a corresponding GPU resource. In an implementation, the physical condition of each GPU resource includes a temperature of corresponding GPU resource, a clock cycle of each core associated with the corresponding GPU resource, an internal memory of the corresponding GPU resource, and/or a power supply of the corresponding GPU resource. The logical condition of each GPU resource includes a failure of a plugin associated with corresponding GPU resource, a startup issue associated with the corresponding GPU resource, a runtime failure, and/or a security breach.

The set of performance parameters corresponding to each GPU resource are compared with a pre-defined set of performance parameters. The pre-defined set of performance parameters indicates performance parameters of an ideal GPU resource. Based on the comparison, an anomaly in a GPU resource of the set of GPU resources may be determined. The anomaly indicates a deviation in the set of performance parameters from the pre-defined set of performance parameters. In some embodiments, the pre-defined performance parameters may be a range of values within which the GPU resource is considered as a GPU resource without a fault. When the anomaly is detected in the GPU resource, another GPU resource is identified from remaining GPU resources available in the computing system. A replaceable GPU resource is identified by matching the computation capacity of the replaceable GPU resource with the computation capacity of each GPU resource of the dedicated AI cluster. Post identification, the failed GPU resource is released from the dedicated AI cluster and the replaceable GPU resource is patched to the dedicated AI cluster. In such a way, a set of replaceable GPU resources may be reserved for replacement of a failed GPU resource of the dedicated AI cluster.

During patching of the replaceable GPU resource to the dedicated AI cluster may be terminated when a pre-defined condition is determined. The pre-defined condition is a failure of the replaceable GPU resource during launch, a failure of the replaceable GPU resource to join the dedicated AI cluster, a workload failure of the replaceable GPU resource, and/or a software bug detected in the replaceable GPU resource. In case of determination of the pre-defined condition, a tag may be associated with the replaceable GPU resource. The tag indicates unsuitability in patching of the replaceable set of GPU resources.

In some embodiments, the computing system may monitor the computation capacity of each GPU resource of the set of GPU resources. The set of GPU resources are reserved for the client for a period of time. During the period of time, the operation may not consume all the computation capacity reserved for the client. In such a case, some of the GPU resources from the set of GPU resources are not utilized for performing the operation requested by the client. The computing system identifies the GPU resources that are not utilized by the client based on the computation capacity. Further, attributes of the operation are determined based on an analysis of an input and an output of the operation. A dummy operation is generated using the attributes of the operation. In some embodiments, the dummy operation may be the same operation (e.g., exactly the same) as an actual operation performed by the client. For example, the dummy operation may process the same data that is processed by the actual operation, and the way that the data is processed may be the same across the dummy and actual operations. The dummy operation is executed on the GPU resources that are not utilized by the client.

In case the computing system receives a request to access the GPU resources for performing the operation, the dummy operation is terminated from the execution of the dummy operation for performing the actual operation requested by the client. Thus, the time for loading the GPU resource from idle condition is mitigated. As a result, the latency of the overall process of the operation is enhanced.

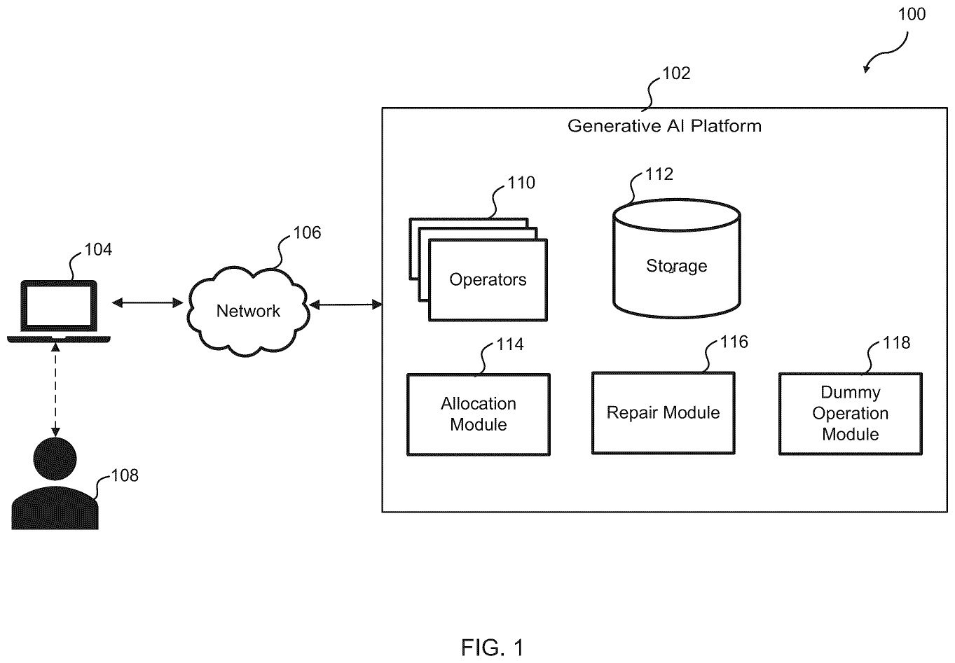

FIG. 1 illustrates a block diagram of a computing system 100 for providing and supporting a generative Artificial Intelligence (AI) platform 102, according to an exemplary embodiment. The computing system 100 supports the provision of a generative AI in response to a request received from a client. The generative AI platform 102 is communicatively coupled to a client system 104 through a network 106. It is noted that a single-client system 104 (e.g., shown as client system 104) is for illustration, and the scope of the present disclosure is not limited to it. The computing system 100 may host several client systems 104 sequentially, alternatively, or parallelly. Each client system 104 is associated with a corresponding client 108.

The network 106 may include suitable logic, circuitry, and interfaces configured to provide several network ports and several communication channels for transmission and reception of data and/or instructions related to operations of the generative AI platform 102 and the client system 104. The network 106 could include a Wireless Area Network (WAN), a Local Area Network (LAN), and/or the Internet for various embodiments. Some computing systems 100 could have multiple hardware stations throughout the warehouse or factory lines connected by the network 106. There could be distributed plants at different locations tied together by network 106.

The client system 104 may include various types of computing systems such as Personal Assistant (PA) devices, portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head-mounted displays and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. Client system 104 108 may be capable of executing various applications such as various Internet-related apps and communication applications (e.g., E-mail applications, short message service (SMS) applications) and may use various communication protocols.

The Generative AI platform 102 includes operators 110 that controls modules of the generative AI platform 102. The operators 110 manage whole life cycle of resources, such as dedicated AI cluster, fine tuning jobs, and/or serving models. The operators 110 utilize Kubernetes to perform various operations. In some embodiments, the operators 110 include a dedicated AI cluster (DAC) operator, a model operator, a model endpoint operator, and a Machine Learning (ML) jobs operator.

The DAC operator utilizes Kubernetes to reserve capacity in generative AI data plane. Generative AI is responsible for reserving a particular number of GPU resources for a client. The DAC operator manages the lifecycle of the DAC including capacity allocation, monitoring, and patching. The model operator handles the life cycle of a model, including both base model and fine-tuned model, the model endpoint operator manages the lifecycle of provisioning and hosting pre-trained or fine-tuned model (storage, access, encryption). The ML jobs operator provides services of the ML models that orchestrates execution of long-running processes or workflows.

The generative AI platform 102 further includes a storage 112 for temporarily or permanently storing data for performing various operations. For example, the storage 112 stores instructions executable by the operators for performing operations. Additionally, the storage 112 stores training and testing data for the ML models.

The generative AI platform 102 includes several modules for performing separate tasks. In some embodiments, the generative AI platform 102 may include an allocation module 114 for allocating/reserving GPU resources for a particular client in response to a request received from the client. The request is received from the client system 104 through the network 106. The allocation module 114 is responsible for managing uptime and patching nodes to form the DAC. The DAC is some amount of computation capacity reserved for an extended period of time (e.g., at least a month). The allocation module 114 may then provide and maintain the computation capacity for the client, who requires predictable performance and throughput for their operation. Functions of the allocation module 114 are described in detail through subsequent paragraphs.

The generative AI platform 102 further includes a repair module 116 for repairing the DAC when an anomaly is detected in a GPU resource of the DAC. The DAC is repaired by identifying a new GPU resource that is compatible with the DAC. The new GPU resource is replaced with defective GPU resource by releasing the defective GPU resource and patching the new GPU resource within the DAC. Functions of the repair module 116 are described in detail through subsequent paragraphs.

The generative AI platform 102 further includes a dummy operation module 118 for executing a dummy operation on the GPU resources which are unutilized by the client. For such purpose, the GPU resources which are reserved for the client but not utilized are identified. Further, dummy operation module 118 executes the dummy operation of the identified GPU resources. When the generative AI platform 102 receives a request to access the identified GPU resources for performing actual task, the dummy operation module 118 terminates the dummy operation on the identified GPU resources and provides the GPU resources for performing actual task. In such a way, a cold start of GPU resources in order to perform actual task is mitigated. As a result, latency of execution of the actual task reduces. Functions of the dummy operation module 118 are described in detail through subsequent paragraphs.

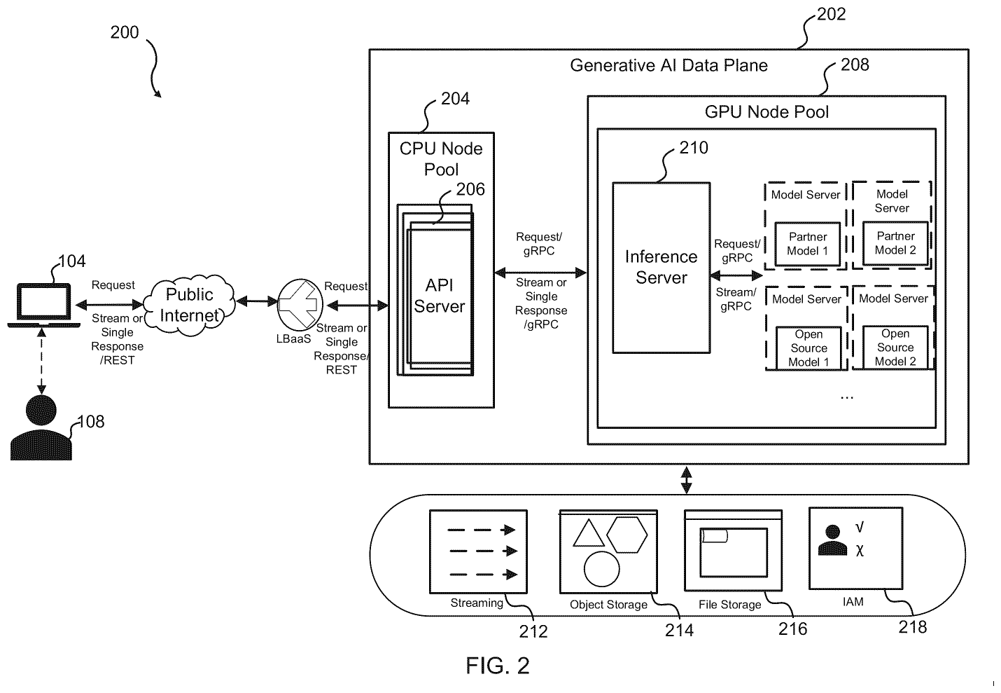

FIG. 2 illustrates an exemplary architecture 200 of a data plane of the generative AI platform 102, according to an exemplary embodiment. As illustrated in FIG. 2, a generative AI data plane 202 receives a service request from the client system 104 associated with the client 108. The service request may be and/or include a request for performing an operation. For example, the client 108 may host a website that is configured to receive input that requests particular information (e.g., via selecting one or more options or providing a text input). The service request may be defined to include the input or a transformed version thereof (e.g., that introduces some structure). The request may be transmitted through a network (e.g., the Internet) and/or a Load Balancer as a Service (LBaaS). The generative AI data plane 202 includes a CPU node pool 204 having multiple API servers 206. Each API server may receive a corresponding request and may forward the request to a GPU node pool 208. Each component of the API server 206 is described in further detail in successive paragraphs.

The GPU node pool 208 includes a fine-tuned inference server 210 for translating the service request to generate one or more prompts executable by one or more data models, such as a partner model or an open-source model. The generative AI data plane 202 may be connected to a streaming module 212, an object storage module 214, a file storage module 216, and/or an Identity and Access Management (IAM) module 218. Each module (including the streaming module 212, the object storage module 214, the file storage module 216, and the IAM module 218) may be configured to perform processing as configured. For example, the streaming module 212 may be configured to support metering and/or billing, the object storage module 214 may be configured to store instances of executable programs, the file storage module 216 may be configured to store ML models and other supporting applications, and the IAM module 218 may be configured to manage authentication and authorization of the client.

In one implementation, the generative AI platform 102 provides various services to the client. Some of the services are provided via Table 1.

TABLE 1

| | | API | Operation | Response | Request | Response | |
|---|---|---|---|---|---|---|---|
| | Operation | Path | Type | Code | Object | Object | Description |
| List | GET | {endpoint}/ | Sync | 200 | N/A | ModelCollection | List the Models |
| Models | | models | | | | | available to the |
| | | | | | | | tenancy |
| Get | GET | {endpoint}/ | Sync | 200 | N/A | Model | Return the |
| Model | | models/ | | | | | Model resource |
| | | {model- | | | | | identified by the |
| | | id} | | | | | model ID |
| Generate | POST | {endpoint}/ | Sync/Stream | 200 | GenerateTextDetails | GenerateTextResult | Generate text |
| Text | | actions/ | | | | | based on prompt |
| | | generateText | | | | | |
| Embed | POST | {endpoint}/ | Sync | 200 | Embed | EmbedTextResult | Create |
| Text | | actions/ | | | TextDetails | | embedding |
| | | embedText | | | | | representation |
| | | | | | | | for the |
| | | | | | | | given text |
| Summarize | POST | {endpoint}/ | Sync | 200 | SummarizeTextDetails | SummarizeTextResult | Summarize text |
| Text | | actions/ | | | | | based on given |
| | | summarizeText | | | | | text |

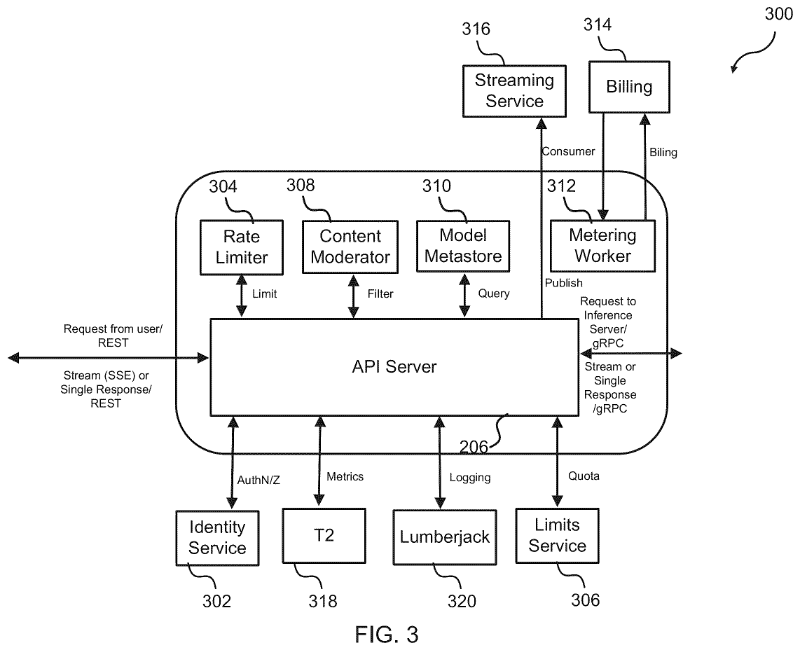

FIG. 3 illustrates a block diagram 300 of the API server 206, according to an exemplary embodiment. The API server 206 is capable of receiving and managing a service request from a client. The service request may be a request for generating text or fine-tuning of AI models. The API server 206 utilizes various components for processing the service request, embedding the service request to inferencing components and returning a response to the service request to the client.

The API server 206 integrates with an identity service module 302 for performing authentication of the service request. The identity service module 302 extracts client identifier (ID) from the service request and authenticates the service request based on the client ID. In some embodiments, the request is authenticated using a private key extracted from an asymmetric key pair associated with the client ID.

After authentication, the service request is provided to a rate limiter 304. The rate limiter 304 tracks the service request of each client 108 received from the client system 104. The rate limiter 304 integrates with a limits service 306 for obtaining pre-defined limits, such as a number of requests per minute (RPM) and a pre-approved quota that are allowed for each client system 104. The pre-approved quota (input/output) varies from request to request. For example, a service request can consume a pre-defined pre-approved quota, for example between 10 to 2048 tokens for small and medium LLMs, while larger and more powerful LLMs allow up to 4096 tokens.

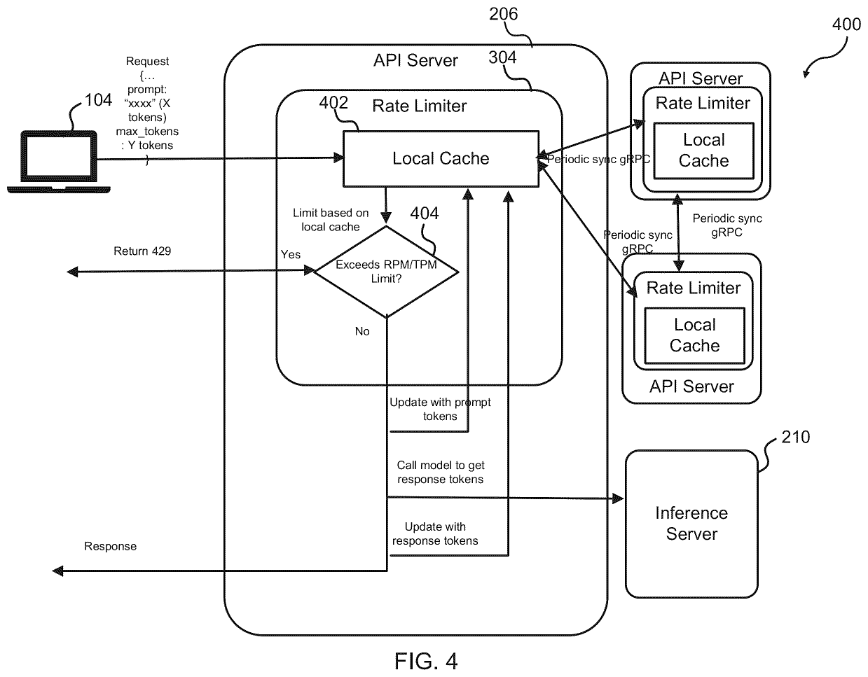

The rate limiter 304 extracts a number of input tokens and a pre-approved quota for output associated with the service request. The rate limiter 304 limits the rate of incoming service requests from the client system 104 using the pre-defined limits obtained from the limits service 306. The rate limiting may be performed as RPM-based rate limiting or a token-based rate limiting. The rate limiter 304 may allow a pre-defined quantity of tokens per minute per model for each client system 104. In yet another implementation, the limits may be imposed based on tenancy ID or client ID associated with the client system 104 as the key. Functions of the rate limiter 304 are explained in detail with respect to FIG. 4.

The API server 206 further includes a content moderator 308 for filtering contents included in the service request by removing sensitive or toxic information from the service request. In an implementation, the content moderator 308 filters training data before training and fine tuning of LLM. In such a way, LLM response does not give responses about sensitive or toxic information, such as how to commit crimes or engage in unlawful activities, and monitoring model response by filtering or halting response generation if the result contains undesirable contents.

The API server 206 further includes a model metastore 310. The model metastore 310 may be a storage unit configured to store LLM-related metadata, such as LLM capabilities, display name, and creation time. The model metastore 310 can be implemented in two ways. The first implementation is an in-memory model metastore, where metadata is stored in an in-memory cache. The model metastore 310 is populated using resource file(s) that are code-reviewed and checked into a GenAI API repository. During deployment of the API server 206, the model-related metadata is loaded into the memory. Second implementation is using a persistent model metastore. The persistent model metastore enables custom model training or fine-tuning. In the persistent model metastore, data related to LLM models (both pretrained and custom-trained) are stored in a database. The API server 206 may query the model metastore 310 for LLM-related metadata. The model metastore 310 may provide the LLM-related metadata in response to the query.

The API server 206 further comprises a metering worker 312 for scheduling the service request received from the client system 104. The metering worker 312 is communicatively coupled to a billing server 314. The metering worker 312 processes the service request and communicates with the billing server 314 to generate a bill regarding each process performed for the service request. The API server 206 is communicatively connected with a streaming service 316 for providing a lightweight streaming solution to stream tokens back to the client system 104 whenever a token is generated.

The API server 206 is communicatively connected with a prometheus T2 unit 318. The prometheus T2 unit 318 is a monitoring and alerting system internally developed within the infrastructure. The prometheus T2 unit 318 enables the API server 206 to scrape metrics from various sources at regular intervals. By utilizing prometheus T2, the API server 206 gains the ability to collect a wide range of metrics, such as GPU utilization, latency, CPU utilization, LLM performance, etc. These metrics can then be used for creating alarms and visualizations in Grafana, providing valuable insights into performance of generative AI services associated with the LLM model, health of the LLM model, and resource utilization by the LLM model.

The generative AI services utilizes a logging architecture that combines Fluent Bit and Fluentd. Fluent Bit is deployed as a daemonset, running on each GPU resource, and will act as a log forwarder. It efficiently collects logs from various GPU resources within API server 206 and sends them to Fluentd. Fluentd, functioning as an aggregator, receives logs from Fluent Bit and performs further processing or filtering if needed. periodically flush the logs to Lumberjack 320, a log shipping protocol, at defined intervals. This architecture enables efficient log collection, aggregation, and transmission, ensuring comprehensive and reliable logging for the Generative AI services.

FIG. 4 illustrates a data flow diagram 400 of the rate limiter 304, according to an exemplary embodiment. The rate limiter 304 may utilize platform-throttling, a battle-tested, and widely adopted distributed rate-limiting solution. Such solution is based on peer-to-peer protocol. The API server 206 periodically broadcasts its local traffic history stored in its local cache to its peers using google Remote Procedure Calls (gRPC) protocol. When a service request is received, the rate limiter 304 in the API server 206 makes a local decision based on a local cache-a representation of global traffic history.

At block 402, the service request is received by the API server 206 from the client system 104. The request may be received in a local cache. At block 404, the rate limiter 304 associated with the API server 206 decides whether the service request exceeds any of the throttling policies, such as the quantity of input tokens received from the client until a current time. If the service request does not exceed the pre-defined limits, the local cache may be updated with the quantity of input tokens at block 406. If the service request exceeds the pre-defined limits, a reply may be returned as “429” “Too Many Requests back to the client”.

Further, the rate limiter 304 may access the LLM model and identify the quantity of output tokens. For streaming case, the rate limiter 304 may accumulate the output tokens as they are streamed. The rate limiter 304 may update the local cache with the quantity of output tokens. If the quantity of response tokens exceeds the token permits at that time, the service may not throttle that service request to maintain good client experience, given the client has already waited for some time and all the work has been done.

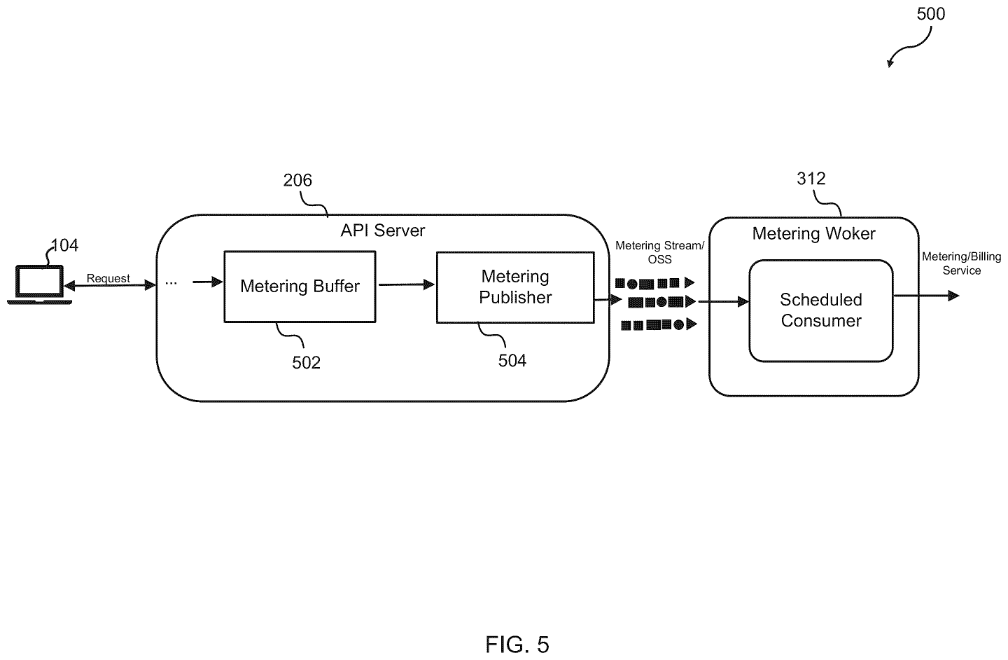

FIG. 5 illustrates a block diagram 500 of the metering worker 312, according to an exemplary embodiment. The API server 206 may include the metering buffer 502 for temporarily storing the service request received from the client system 104. The service request may be transferred to a metering publisher 504 sequentially. The metering publisher 504 may send the service requests to the metering worker 312 where each request is scheduled for processing. The billing server 314 may generate a bill regarding each process performed for the service request.

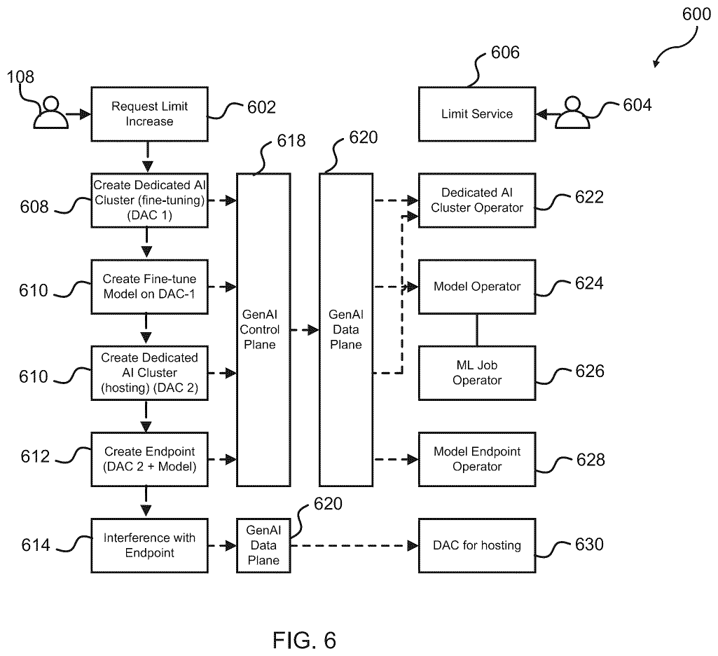

FIG. 6 illustrates a high-level design diagram 600 for creation of a dedicated AI cluster (DAC), according to an exemplary embodiment. The generative AI platform receives a request for allocating GPU resources for performing an operation or changing the current allocation of the GPU resources.

The request to allocate GPU resources or change the current allocation of the GPU resources is received at block 602. The change in the current allocation may correspond to request for increasing or decreasing GPU resources currently being utilized by the client. In some embodiments, the generative AI platform may generate a request for increasing or decreasing the GPU resources allocated to the client in response to the increase/decrease of traffic managed by the client 108.

The request for change in the current allocation of the GPU resources is received by an admin 604 who may allow or deny the request using a limit service module 606. This ensures human scrutiny in the GPU resource allocation before allowing the client to tie up scarce and expensive GPU resources. This also provides a communication channel with clients in case GPU resources are not available in region(s) preferred by the client. In such case, the admin 604 can engage with client 108 to suggest alternate region(s) or set may provide a timeline for changing the current allocation via limit request support ticket.

The request may correspond to actions such as creating a dedicated AI cluster (DAC) for fine tuning at block 608, creating a fine-tuning model on the DAC at block 610, creating a DAC for hosting a model providing generative AI services to the client at block 612, creating a model endpoint for interacting with the model hosting the generative AI services at block 614, and creating an interface with the model endpoint at block 616.

Blocks 608-616 are supported via communications with a generative AI control plane (GenAI CP) 618 with and a Generative AI data plane (GenAI DP) 620.

The GenAI DP 620 includes a plurality of Kubernetes operators such as a dedicated AI cluster (DAC) operator 622, a model operator 624, a ML job operator 626, and a model endpoint operator 628. The DAC operator 622 performs functions such as creating a plurality of DACs by reserving a set of GPU resources corresponding to each DAC and monitoring each GPU resource of each of the plurality of DACs for physical and logical failure. The physical failure of a GPU resource corresponds to excessive heating of the GPU resource and other physical parameters associated with the GPU resource such as a clock cycle of core associated with the GPU resource, an internal memory the GPU resource, and a power supply of the corresponding GPU resource by comparing the various physical parameters of the GPU resource with a pre-defined set of physical parameters. Similarly, the DAC operator 622 monitors for logical failure of the GPU resource. The logical failure relates to breach of security protocol associated with the GPU resource, failure of a plugin associated with the GPU resource, and/or failure of the GPU to start and runtime failure of the GPU resource.

The model operator 624 communicatively coupled with the ML job operator 626 performs functions such as managing lifecycle of various base model associated with the generative AI platform. The model operator 624 further performs functions such as managing the lifecycle of a fine-tuned model along with managing the training and artifacts for fine-tuning a base model.

The ML job operator 626 is invoked by the model operator 624 for executing training for creation of the fine-tuned model and managing training workload. The ML Job operator 626 further implements the logic for management of lifecycle of workflow resources, including task and host failure recovery. The ML job operator 626 further provides simplified and auditable surface area for access permissions. The ML Jobs operator 626 has a limited, well-defined scope and access controls. ML Jobs managed resources are visible throughout an AI platform (AIP) ecosystem (console, logs, ML Ops tooling).

The model endpoint operator 628 creates a model endpoint through communication between the GenAI CP 618 and the GenAI DP 620. At block 630, the generative AI platform provides the DAC for hosting the operation associated with the request received from client 108.

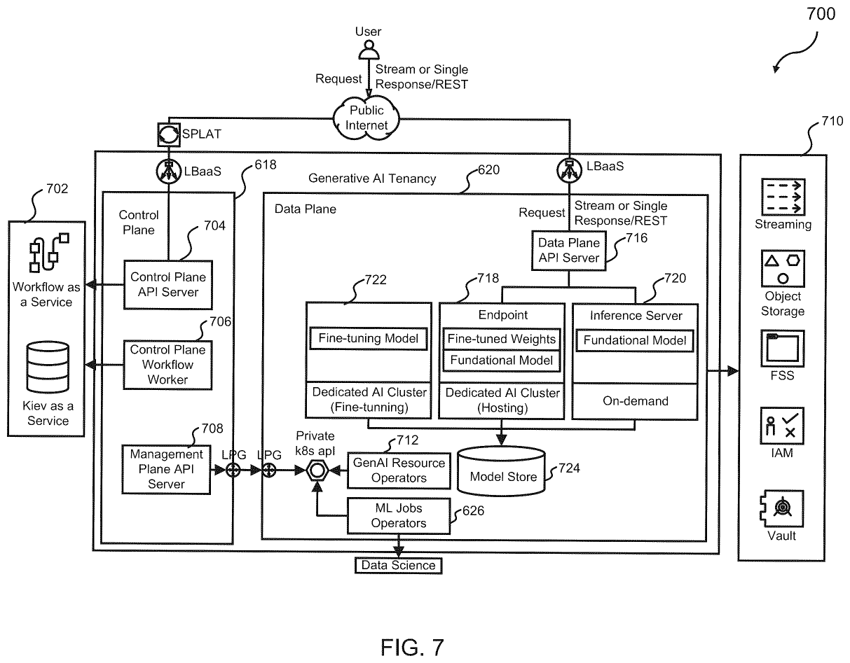

FIG. 7 illustrates a block diagram of a system 700 configured for creating dedicated AI, according to an exemplary embodiment. System 700 includes the GenAI CP 618. The GenAI CP 618 may have a control plane API (CP API) server 704, a control plane (CP) workflow worker 706, and a management plane API (MP API) server 708. The CP API server 704 serves as an entry point to the GenAI CP 618. The CP API server 704 receives a request from a client via a public internet. The CP API server 704 is a Dropwizard app from Pegasus-generated template. The CP API server 704 provides Workflow as a Service (WFaaS) in response to the request. The request corresponds to operations such as of creation, reading, updating, or detection (CRUD) of GPU resources associated with the client, handling of the GPU resources, retry and idempotency of GPU resources, logging into the GPU resources associated with the client, and emitting metrics corresponding to the GPU resources associated with the client.

The CP workflow worker 706 is communicatively coupled to the CP API server 704 and is also a Dropwizard app from Pegasus-generated template. Many of the CRUD operations are long-running and multi-step in nature. As a result, WFaaS is utilized by the CP workflow worker 706 to orchestrate the CRUD operations or long running jobs and managing lifecycle of the workflow. The workflow includes a validation step, a GPU resources CRUD step, a poll step, an update Kiev step, and a clean-up step. In the validation step, the CP workflow worker 706 performs a sync check and/or re-validations on conditions that might have changed between the request being accepted by CP API server and the request being picked up by CP workflow worker 706. In the GPU resources CRUD step, the CP workflow worker 706 passes the operation to the MP API server 708 by invoking corresponding management plane API. In the poll step, the CP workflow worker 706 periodically polls the state of a job via the MP API server 708 if it is still in progress, until the job reaches a terminal state. In the update Kiev step, after a job corresponding to the request is completed, the CP workflow worker 706 updates job metadata, including lifecycle state, lifecycle details, and percentage of completion of the job, in Kiev as a Service (Kaas) to reflect the updated progress. In the clean-up step, in case of workflow failure, the CP workflow worker 706 cleans up items produced in previous steps of the failed workflow to ensure an overall consistent state. WFaas and KaaS are together referred to by block 702, as illustrated in FIG. 7.

The MP API server 708 derives intent or configuration of the request from the client. The MP API server 708 communicatively coupled to the GenAI DP 620 via local peering gateway (LPG). The GenAI DP 620 hosts resources such as dedicated AI Clusters (DACs), LLMs/AI models, and AI model inference endpoint and helps the MP API server 708 in carrying out the intent derived from the request.

The GenAI DP 620 constructs a DAC that is a logical construct of reserved capacity in the GenAI DP 620. Generative AI is responsible for keeping the underline infrastructure (GPUs) reserved and running for a particular customer. The DAC Operator manages the lifecycle of a dedicated AI cluster, including capacity allocation, monitoring, and patching.

Examples of such intents are creating dedicated AI clusters, fine tuning jobs on the AI models, and creating dedicated inference endpoint on a particular base AI model, or fine-tuned AI model. The state of the MP API server 708 is stored back in control plane Kiev.

Further, the intent may include using the DAC for hosting various AI services for the client such as streaming services, object storage, File Storage System (FSS), Identity and Access Management (IAM), vault, etc. Such AI services are referred to as block 710, as illustrated in FIG. 7.

The MP API server 708 is responsible for provisioning DACs, scheduling fine tuning or dedicated inference endpoint processes on DACs, monitoring the DACs and processes, and performing automatic maintenance and automated upgrades on the DACs and the processes. The MP API server 708 invokes Gen AI resource operators 712 and ML job operator 626 to manage the whole life cycle of resources of the GenAI DP 620. The GenAI DP 620 includes a data plane API server 716 for controlling a model endpoint 718 and an inference server 720. The model endpoint 718 includes fine-tuned weights corresponding to the fine-tune model. The base model may be fine-tuned based on the weights assigned to the corresponding model. The inference server 720 is utilized for hosting various AI services for the client such as streaming services, object storage, File Storage System (FSS), Identity and Access Management (IAM), vault, etc. The model endpoint 718 and the inference server 720 may be controlled by the data plane API server 716 to fine-tune a fine-tuning model 722.

The data plane further includes a model store 724. The model store 724 stores data related to the fine-tuning model 722, the model endpoint 718, and the interference server 720. The model endpoint 718 and the interference server 720 are utilized by the data plane API server 716 to provide response to the client based on the intent. The response to the request may be in the form of a single response i.e., token-based response.

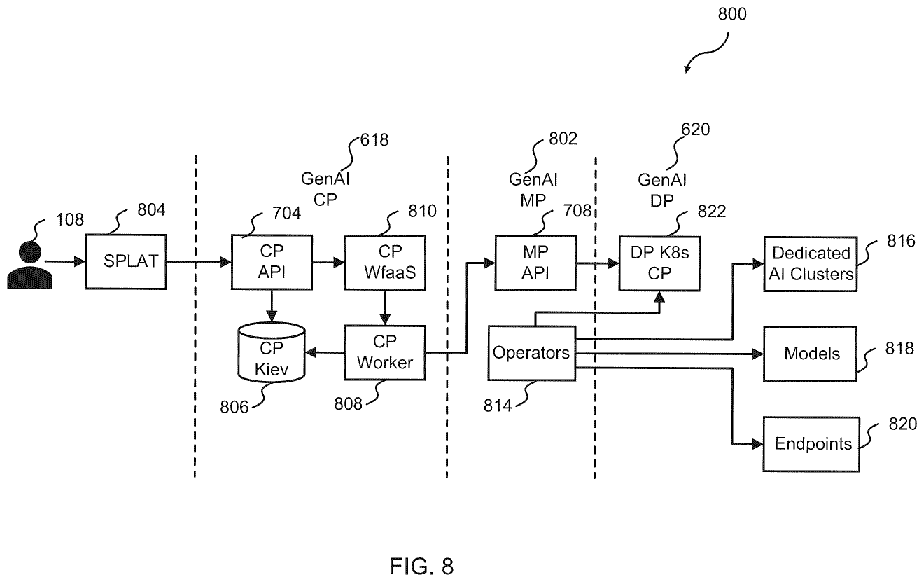

FIG. 8 illustrates a flow diagram 800 of a control plane request being propagated to a management plane and then a data plane of a generative AI platform 800, according to an exemplary embodiment. As illustrated in FIG. 8, the generative AI platform 800 receives a request from a client 108. In some embodiments, the request may correspond to allocation of GPU resources for a fixed period of time or changing the number of GPU resources currently being utilized by the client by increasing or decreasing the GPU resources currently allocated to the client. In some other embodiments, the request corresponds to operations such as of creation, reading, updating, or detection (CRUD) of GPU resources associated with the client, handling of the GPU resources, retry and idempotency of GPU resources, logging into the GPU resources associated with the client, and emitting metrics corresponding to the GPU resources associated with the client.

The request may be received at GenAI CP 618 through SPLAT 804. SPLAT 804 provides the service including authorization of the request based on a client identifier (ID) of the client. SPLAT 804 verifies the identity of a client system 104 associated with the client. For example, SPLAT 804 verifies the range of services/request permitted to the client based on the client ID. The range of services includes the number of requests allowed to the client. In some embodiments, the request is authenticated using a private key extracted from an asymmetric key pair associated with the client ID. After authentication, SPLAT 804 forwards the request to the generative AI platform 800.

The generative AI platform 800 includes a GenAI CP 618, a generative AI management plane (GenAI MP) 708, and a GenAI DP 620. The request may be received by GenAI CP 618. The GenAI CP 618 includes a control plane API (CP API) server 704, a control pane (CP) Kiev 806, a control plane (CP) worker 808, and a control plane Workflow as a Service (CP WFaaS) 810. The CP API server 704 serves as an entry point to the GenAI CP 618. The CP API server 704 is configured to provide workflow as a service in response to the request.

The CP worker 808 is communicatively coupled to the CP API server 704 and orchestrates the CRUD operations which are long running jobs as well as manages lifecycle of the workflow for carrying out the CRUD operations. The CRUD operations may be managed by various steps, such as a validation step, a GPU resources CRUD step, a poll step, an update Kiev step, and a clean-up step. Above mentioned steps are already described with reference to FIG. 7.

The CP Kiev 806 stores metadata associated with the request. The metadata includes an identity of the client system 104 associated with client 108, the data with respect to the various types of operation to be performed, and requirements associated with the various types of operations. For example, the various types of operations may include a fine-tuning operation of a base AI model, a request for a predefined throughput and latency while using the generative AI platform, a request to obtain an AI model for streaming or other services etc. CP Kiev 806 further stores the status of an operation/job included in the request as discussed in FIG. 7.

The CP worker 808 interacts with the GenAI MP 802. GenAI MP 802 includes a management plane API (MP API) server 708 and operators 814. MP API server 708 receives the request from the GenAI CP 618 and derives intent/configuration of the request based on the metadata associated with the request.

Examples of such intents are creating dedicated AI clusters, fine tuning jobs on the AI models, and creating dedicated inference endpoint on a particular base AI model, or fine-tuned AI model, ensuring a predefined throughput and latency. Further, the intent may include usage of the DAC for hosting various AI services for the client such as streaming services, etc.

The operators 814 leverages the Kubernetes custom resource for performing various operations according to the request. The operations may be performed in the GenAI DP 620. In one implementation, the GenAI MP 802 may invoke the DAC operator 622 to create DACs 816 using GPU resources. In another implementation, the GenAI MP 802 may invoke ML job operator 626 to manage models 818, such as the whole life cycle of resources of the CRUD operation for a dedicated AI clusters based on the request metadata. In yet another implementation, the GenAI MP 802 may invoke model endpoint operators 628 to create and manage AI model endpoints 820 for establishing an interface with the AI model requested by the client 108.

In some embodiments, when the request metadata suggests a requirement of a certain amount of GPU resource in the GenAI DP 620 for a fixed amount of time, the DAC operator retrieves attributes of the available GPU resources in the GenAI DP 620. The attributes are retrieved from a Kubernetes CP 822. The attributes of the available GPU resources are compared with the GPU resource requirement suggested by the request metadata. The DAC operators then create a dedicated AI cluster (DAC) 816 comprising a set of GPU resources that satisfies the requirement suggested by the request metadata.

The DAC operators create DAC 816 based on the type of operation to be performed by the client. For example, in case the request metadata indicates the type of operation is a fine-tuning operation, the DAC operators create the DAC 816 by acquiring all the GPU resources from a single location or a single pool of GPU resources. For other operations, the DAC operators may generate the DAC 816 using a set of GPU resource in which the GPU resources are acquired from different location or multiple pool of GPU resources.

Once the DAC is created, the DAC is associated with the client system 104 ID and reserved to be used by client 108.

In each of the DAC, the DAC operators run a dummy program until the DAC is requested by its corresponding client and terminates the dummy program the DAC is requested by the client after its creation. This helps to avoid the latency due to cold start of the GPU resources.

Further, the DAC operators monitor GPU resources in the DAC for physical and logical failure. The physical failure of a GPU resource may correspond to excessive heating of the GPU resource and other physical parameters associated with the GPU resource such as a clock cycle of core associated with the GPU resource, an internal memory the GPU resource, and a power supply of the corresponding GPU resource by comparing the various physical parameters of the GPU resource with a pre-defined set of physical parameters. Similarly, the DAC operators determine the logical failure of the GPU resource. The logical failure may relate to breach of security protocol associated with the GPU resource. Further, the logical failure may relate to failure of a plugin associated with the GPU resource, failure of the GPU resource to start and runtime failure of the GPU resource.

Once a GPU resource in the DAC is determined to be malfunctional due to either physical or logical failure the DAC operators determines a replacement for the mal functional GPU resource from a cluster of GPU resource reserved for replacement purpose. The replacement GPU resource is selected from plurality of GPU resources in the cluster of GPU resources reserved for replacement purpose such as the rotation hash value of the replacement GPU resource with rotation hash value of the DAC.

Once the replacement GPU resource is determined, the mal functional GPU resource is released from the DAC and the replacement GPU resource is patched with the DAC, by DAC operator.

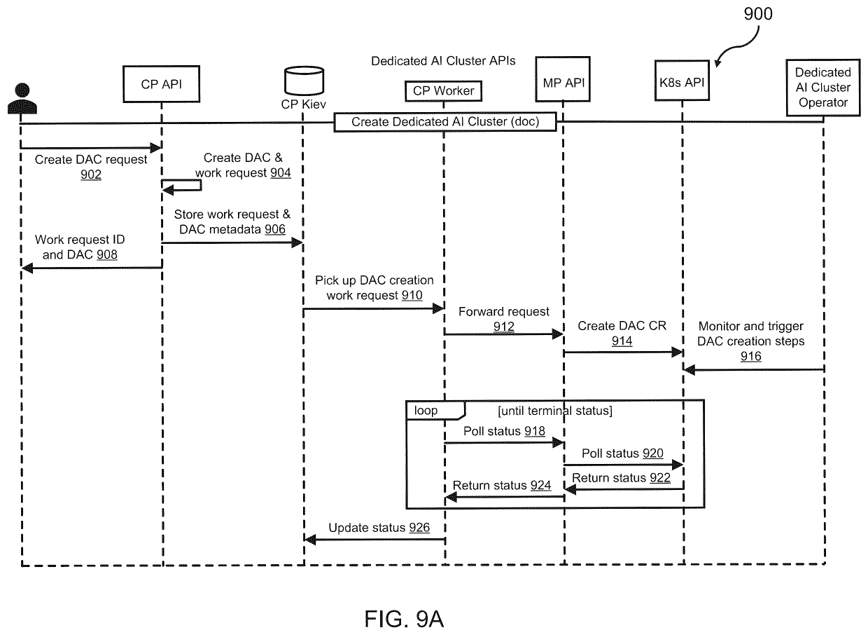

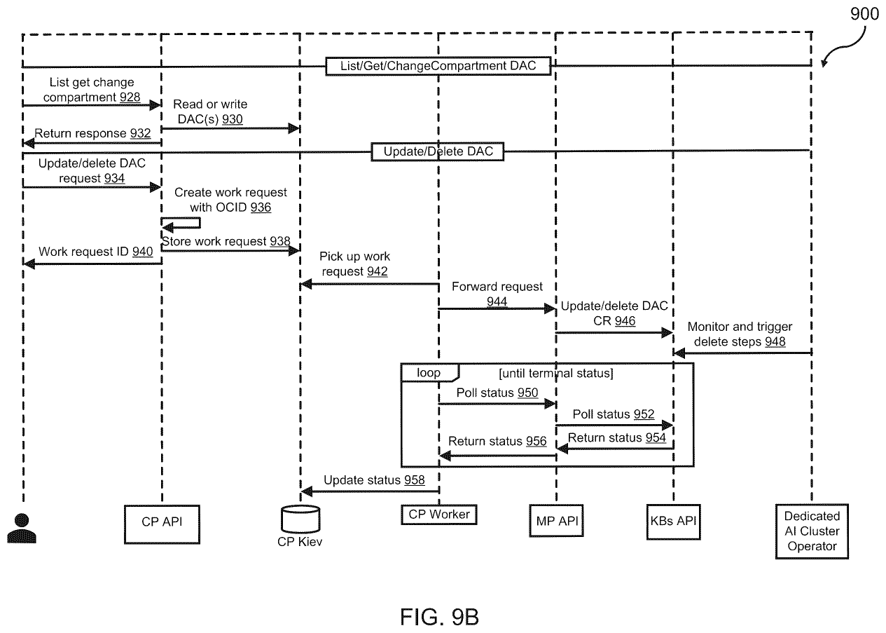

FIGS. 9A and 9B illustrate a sequence diagram 900 of the process of creation of DACs, according to an exemplary embodiment. The process may be sequentially followed by various modules such as, a CP API server, a CP Kiev, a CP worker, an MP API server, a K8s API server, and a DAC operator. The CP API server receives a DAC request for creating a DAC, at step 902. The DAC request includes a client ID of the client. In some embodiments, the DAC request may correspond to allocating computation capacity or increasing the computation capacity. Computation capacity corresponds to the amount of GPU resources available for the client.

In response to the request, the CP API server creates a work request for creating a DAC and associates a work request with the client ID, at step 904. Metadata for creating the DAC (DAC metadata) is provided to the CP API server via the request. DAC metadata may indicate a tenancy, a compartment, and a capacity reserved for the DAC.

The CP API server stores the work request and DAC metadata in CP Kiev, at step 906. The work request ID and the DAC metadata may be transmitted to the client, at step 908.

At step 910, the CP worker receives the DAC creation work request from the CP Kiev. The CP worker forwards the request to the MP API server, at step 912.

In response to the request, the MP API server creates DAC control request, at step 914. The DAC control request may indicate a number of GPU resources for the operation requested by the client. The MP API server stores the request and DAC metadata in Kubernetes custom resource in the data plane using DAC control request, at step 914.

At step 916, the DAC operator triggers the creation of DAC using the Kubernetes custom resource in the data plane and monitors the DAC being created by the Kubernetes operators. In such steps, the Kubernetes custom resource triggers the DAC operator to collect the data related to each GPU resources available for clustering. The DAC operators compare the collected data with the DAC metadata to identify the GPU resources for clustering. The identified GPU resources are patched together to form the DAC.

At step 918, the CP worker requests the poll status of the work request to MP API server. The MP API server forwards the request of the poll status of the work request to the Kubernetes operator, at step 920. At step 922, the Kubernetes operator returns the poll status of the work request to the MP API server. The poll status may be further forwarded to the CP worker, at step 924. The poll status may be updated in the CP Kiev, at step 926.

At step 928, the CP API server receives a request to list get change compartment. The request may correspond to operations, such as list: for listing the AI models available within the generative AI platform, get: for return an AI model, and change compartment: for changing the owning compartment of the AI model. The CP API server reads or writes the DAC metadata stored in CP kiev, at step 930.

At step 932, the CP API server transmits a response to the client. The response includes one of lists of the AI models available within the generative AI platform, return an AI model corresponding to a model ID derived from the request metadata or change the owning compartment of the AI model whose model ID is provided by the client in request metadata.

At step 934, the CP API server receives a request for updating/deleting DAC. The CP API server creates a work request for creating or deleting a DAC and associates the work request with the client system 104 ID, at step 936. Metadata for creating the DAC (DAC metadata) is provided to the CP API server via the request. DAC metadata may indicate the type of operation the client wants to perform on the DAC, the amount of time for DAC requirement, and other information related to lifecycle and management of the DAC.

The CP API server stores the work request and DAC metadata in control plane Kiev, at step 938. The work request ID and the DAC metadata may be transmitted to the client, at step 940.

At step 942, the CP worker picks up the DAC deletion/creation work request from CP Api server. The CP worker forwards the request to the management plane API, at step 944.

In response to the request, the MP API creates DAC control request, at step 946. The MP API server stores the request metadata and the DAC metadata in Kubernetes custom resource in the data plane using DAC control request.

At step 948, the DAC operator triggers the update/delete of DAC using the Kubernetes custom resource in the data plane and monitors the DAC being created by the Kubernetes operators. In such steps, the Kubernetes custom resource triggers the DAC operator to collect the data related to each GPU resources patched into the DAC. The DAC operator updates/deletes the DAC based on the request.

At step 950, the CP worker requests the poll status of the work request to MP API server. The MP API server forwards the request of the poll status of the work request to the Kubernetes operator, at step 952. At step 954, the Kubernetes operator returns the poll status of the work request to the MP API server. The poll status may be further forwarded to the CP worker, at step 956. The poll status may be updated in the CP Kiev, at step 958.

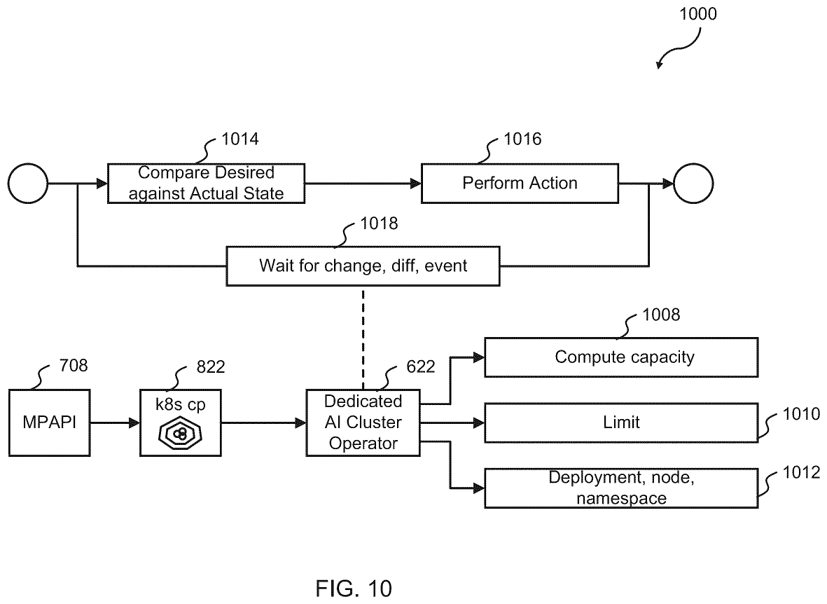

FIG. 10 illustrates a flow diagram 1000 indicating the working of DAC operator 622, according to an exemplary embodiment. As illustrated in FIG. 10, an MP API server 708 receives a request for performing CRUD operation. The MP API server 708 determines DAC metadata using the CRUD operation. The DAC metadata includes custom resource definitions that are stored in a Kubernetes CP 822. The Kubernetes CP provides the DAC metadata to a DAC operator 622. The DAC operator 622 performs the CRUD operation for the DACs and manages the lifetime of the DACs using the CRDs.

DAC operator 622 triggers a function of managing computation capacity 1008 for the DAC. For example, the DAC operator 622 may deploy GPU resources into the dedicated AI cluster or may tear down the GPU resources from the dedicated AI cluster. Further, the DAC operator 622 triggers a function of ensuring a capacity limit 1010 that is configured in the DAC metadata. For example, the DAC operator 622 determines computation capacity of each GPU resources available for clustering and selects a number of GPU resources such that the overall computation capacity of the number of GPU resources lie within the capacity limit 1010. Furthermore, the DAC operator triggers a Kubernetes controller 1012 to perform various operations, such as monitoring and managing health and uptime of the GPU resources, detecting node problems, and patching of new GPU resources in case of detection of node problems.

The DAC operator further makes updates to DACs such compartment changes based on the DAC metadata. The DAC operator performs CRUD operation and updates the DACs. These operations provide a state of the DAC to the client. For example, a state may be compared with an actual state in block 1014. Based on the comparison, the action is performed at block 1016. The operation is kept on hold till any difference or change in event is detected at block 1018.

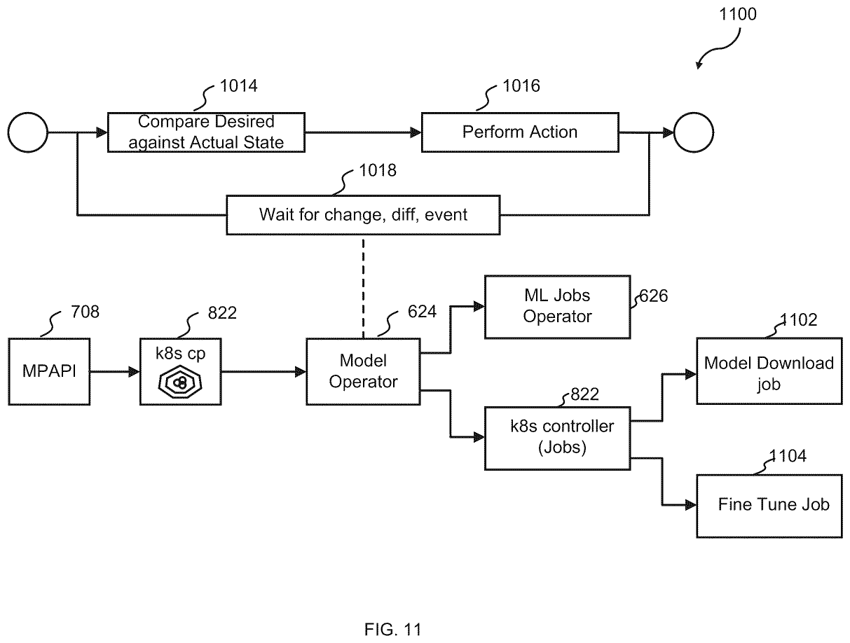

FIG. 11 illustrates a flow diagram 1100 of the process of model operator 624, according to an exemplary embodiment. The model operator 624 manages all the LLMs/AI models and fine-tuned models in the generative AI platform. The model operator 624 can access and store all types of AI models. The AI models in the generative AI platform are either open-source AI models or are obtained by collaborating with one or more providers of the AI model. Each AI model may thus have different specification. (e.g., one of the AI model may be specialized for summarization whereas another AI model may be specialized for text completion). Further, each AI model may potentially have different sizes or parameter counts. Additionally, the AI models from some of the providers may have specialized storage and access methodologies in order to protect the model's intellectual property. Metadata describing each AI model is persisted in the CP Kiev. The CP Kiev acts as a canonical source of truth for all AI model related information.

The DAC operator further makes updates to DACs such compartment changes based on the DAC metadata. The DAC operator performs CRUD operation and updates the DACs. These operations provide a state of the DAC to the client. For example, a state may be compared with an actual state in block 1014. Based on the comparison, the action is performed at block 1016. The operation is kept on hold till any difference or change in event is detected at block 1018.

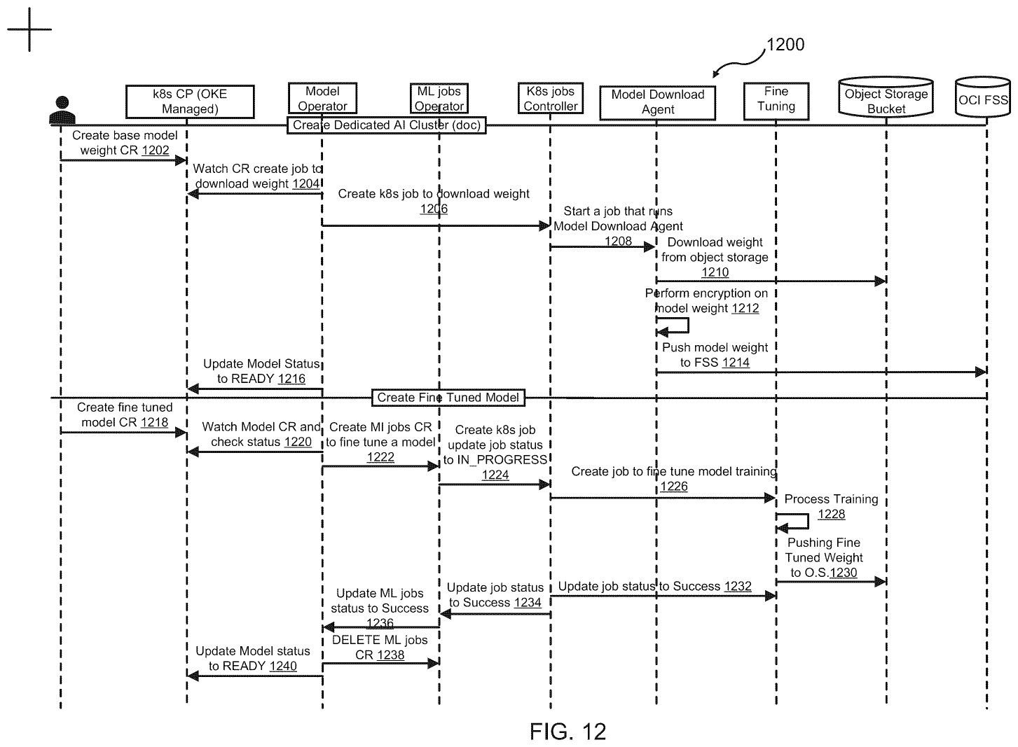

FIG. 12 illustrates a sequence diagram 1200 of the process of creating a base model and fine-tune model custom resource with model operator 624, according to an exemplary embodiment. At step 1202, the control plane Kubernetes receives a request for creating a base AI model weight custom resources. The control plane Kubernetes waits for the model operator to create a Kubernetes job to download the base AI model weight, at step 1204.

At step 1206, the model operator creates the Kubernetes job to download the base AI model weight. At step 1208, the model operator invokes ML job controller to start downloading the AI model weight. At step 1210, the model download agent downloads the base AI model weight from object storage bucket. The model download agent further encrypts the base AI model weight, at step 1212. Further, the model download agent stores the base AI model weight in the FSS, at step 1214 and updates the base AI model status to the CP API server, at step 1216.

At step 1218, a request to create custom resources for a fine-tuned model is received by the control plane Kubernetes. At step 1220, the model operator checks the fine-tuned model custom resources. At step 1222, the model operator creates a ML job for the ML job operator to fine tune the base AI model. At step 1224, the ML job operator creates a Kubernetes job for Kubernetes job controller and updates the job status as in-progress.

At block 1226, Kubernetes job controller creates a job to fine tune the base AI model. At block 1230, the training process is performed by the Kubernetes job controllers to fine-tune the base AI model. At step 1232, fine-tuned model weight is pushed to object storage bucket. At step 1234, Kubernetes job controllers update the status of the job to fine tune the base AI model as successful to the ML job operator. At step 1236, the ML job operator updates the status of the job to fine tune the base AI model as successful to model operator, which further then deletes the ML job custom resources from the ML job operator, at step 1238 and updates the control plane API server that the fine-tuned model is ready to be used, at step 1240.

One challenge inherent in training or fine tuning LLMs/AI models is that the size and complexity of the AI models necessitates the use of multiple powerful GPU resources. The generative AI platform currently requires DACs for model training in order to provide predictable training performance, including training job queue times, training throughput, and cost. While on-demand training (e.g., without requiring reserved capacity) may be provided in the future, GPU resource inventory at present is too low to meet all demand. Thus, fine tuning is restricted to clients who have ordered DACs in order to ensure that important customers (including internal teams such as Fusion Apps) can access this functionality, and to preserve a good client experience for these clients.

In order to fine-tune a model, the client provides a training corpus, typically of multiple examples. The training corpus includes prompt request/response pairs. The fine-tuned model may direct to a variety of tasks, such as text classification, summarization, and entity extraction.

Text classification involves re-purposing the fine-tuned model's capabilities to make predictions based on input text/speech. For example, the fine-tuned model provides a rating for a given product based on the review provided by a client in the form of text or speech. For example, if the review indicates that the product arrived broken, a rating of 0 is provided. If the review indicates super quick shipping or friendly customer service, a rating 1 is provided.

Summarization involves re-purposing the fine-tuned model's capabilities summarize input text/speech. For example, the input “Jack and Jill went up the hill . . . ” is summarized as two children persevere in getting a bucket of water for their mother despite the difficulty of climbing the hill where water is located.

Entity extraction involves re-purposing the fine-tuned model's capabilities to extract entity of interest from input text or speech. For example, if from the input “Doxycycline is in a class of medications called tetracycline antibiotics. It works to treat infections by preventing the growth and spread of bacteria . . . ,” the entity of interest could be the name of medications which are extracted by the fine-tuned model [doxycycline, tetracycline, . . . ].

The fine-tuning of the base AI model includes various steps. For example, the training data is verified to be used to fine-tune a base AI model. After verification, the base AI model is downloaded and decrypted to prepare it for fine-tuning. Once the base AI model is prepared, the fine-tuning logic specific to the base AI model is executed and the fine-tuning operation till the operation is complete is monitored. If the fine-tuning is successful, the fine-tuned model weight and any relevant metrics/logs are stored corresponding to the fine-tuned model.

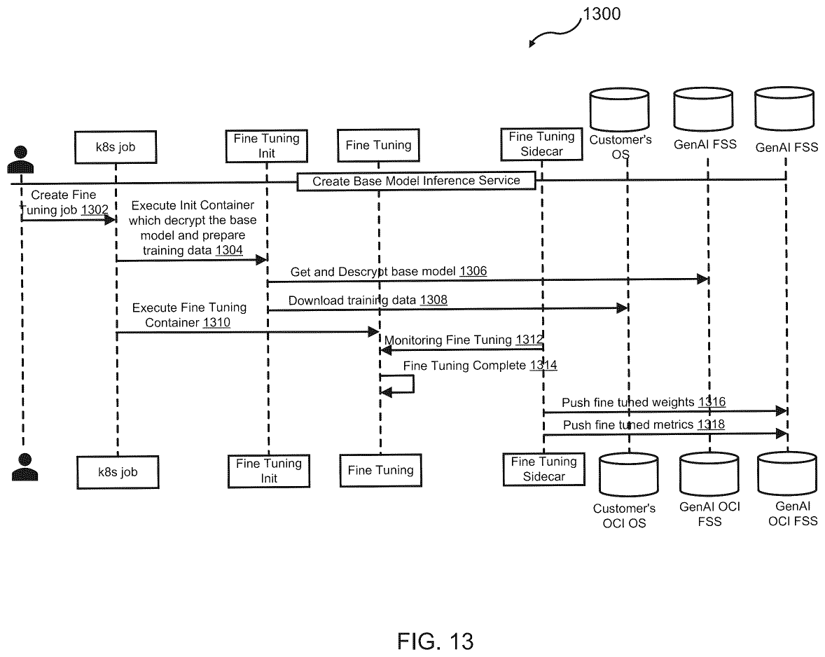

FIG. 13 illustrates a sequence diagram 1300 of a method of fine tuning a base AI model, according to an exemplary embodiment. At step 1302, a request for creating a fine-tuning job is received by a Kubernetes job module. At step 1304, a model operator invokes a Kubernetes job in response to the fine-tuning job. The Kubernetes job executes fine tuning initiator (init) container to prepare training data and decrypt the base model. At step 1306, the fine tuning init container requests the file storage server (FSS) to provide the base AI model for fine-tuning and decrypts the base AI model received from FSS. At step 1308, the fine tuning init container downloads a training data set for the base AI model from object storage of the client.

Once the base AI model and training data set are available, the Kubernetes job invokes a fine-tuning container on the DAC associated with the client for tuning the base-AI model, at step 1310. A fine-tuning sidecar service deployed with the fine-tuning container monitors the fine-tuning process, at step 1312.

When the fine-tuning sidecar observes that the fine-tuning process is complete, at step 1314, it stores the fine-tuned weight and the fine-tuned matric to FSS, at steps 1316 and 1318.

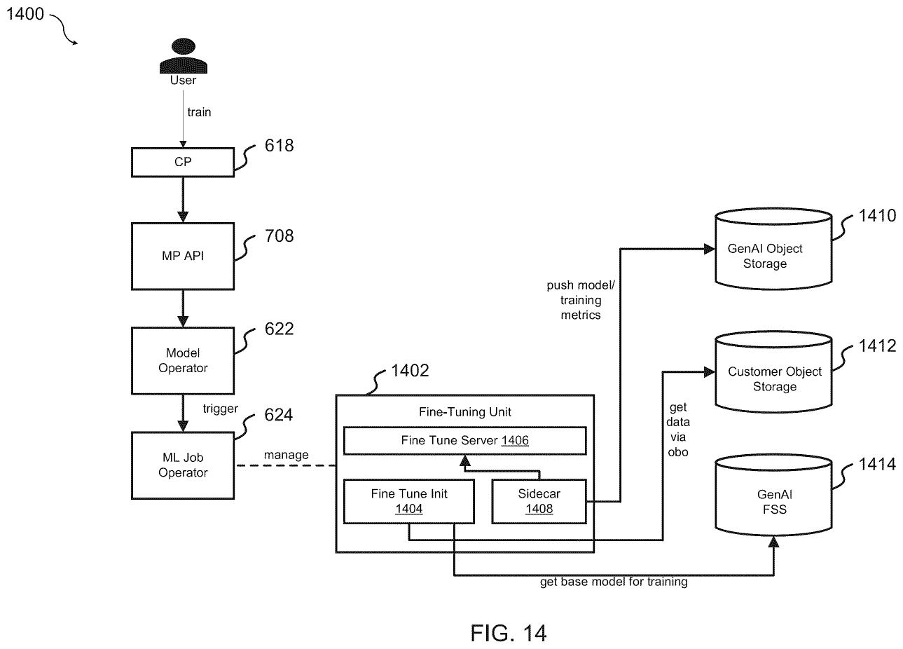

FIG. 14 illustrates a data flow diagram 1400 for fine-tuning of a data model, according to an exemplary embodiment. Initially, for training the data model, training data for a job is received by GenAI CP 618. The training data is further transmitted from GenAI CP 618 to model operator 624 by way of MP API server 708. In response to receiving the training data, model operator 624 generates a trigger signal for ML job operator 626 that is responsible for executing training for creation of the fine-tuned model and managing training workload. ML job operator generates a management signal that enables fine-tuning unit 1402 to fine-tune the data model in accordance with the training data.

Fine-tuning unit 1402 includes fine-tuning initiator (FT init) 1404, fine-tuning server 1406, and fine-tuning sidecar 1408. In response to the reception of the management signal by fine-tuning unit 1402, FT init 1404 provides a fine-tuning environment for the data model. In some aspects of the present disclosure, to provide the fine-tuning environment, FT init 1404 sets up weights for the LLM models stored in the internal memory of the GPU resource. FT Init 1404 further downloads and validates the training data for the job. In some aspects of the present disclosure, FT init 1404 may receive the training data for the job from customer object storage 1412 or as inline data. Preferably, for accessing customer data from customer object storage 1412, an on-behalf-of (OBO) token can be used. FT init 1404 further receives a base model for training from a GenAI file storage system (FSS) 1414. Fine-tuning server 1406 provides a quasi-black box implementation for fine-tuning of the data model. Particularly, fine-tuning server 1406 runs a container that exposes multiple APIs to initiate training of the data model, fetch training metrics, get training status, and shutdown the container upon training the data model. Fine-tuning sidecar 1408 tracks a status of the fine-tuning job, exports model training metrics of interest (such as accuracy and loss, etc.) to GenAI object storage 1410, and exports fine-tuned model weights for the data model to GenAI object storage 1410.

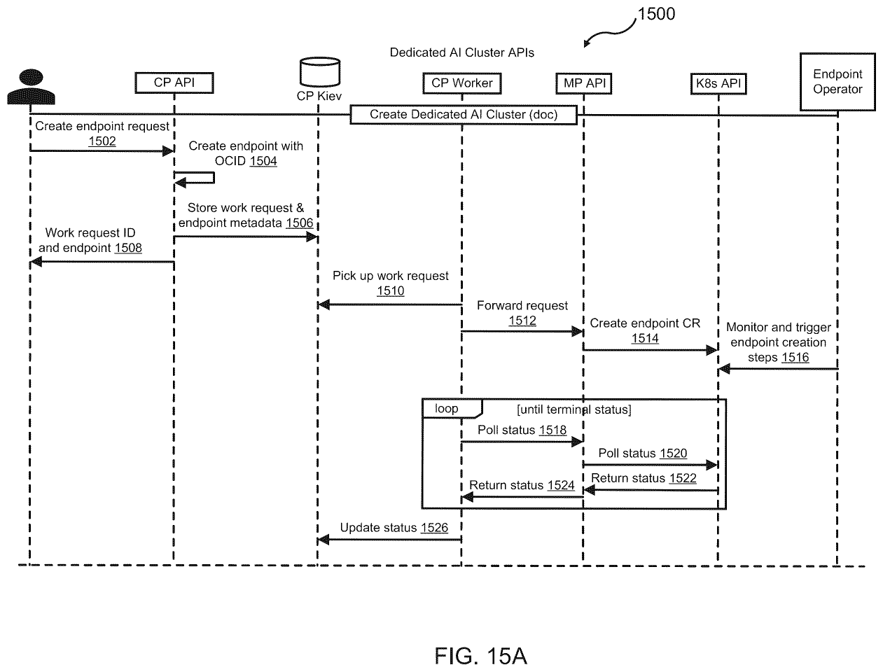

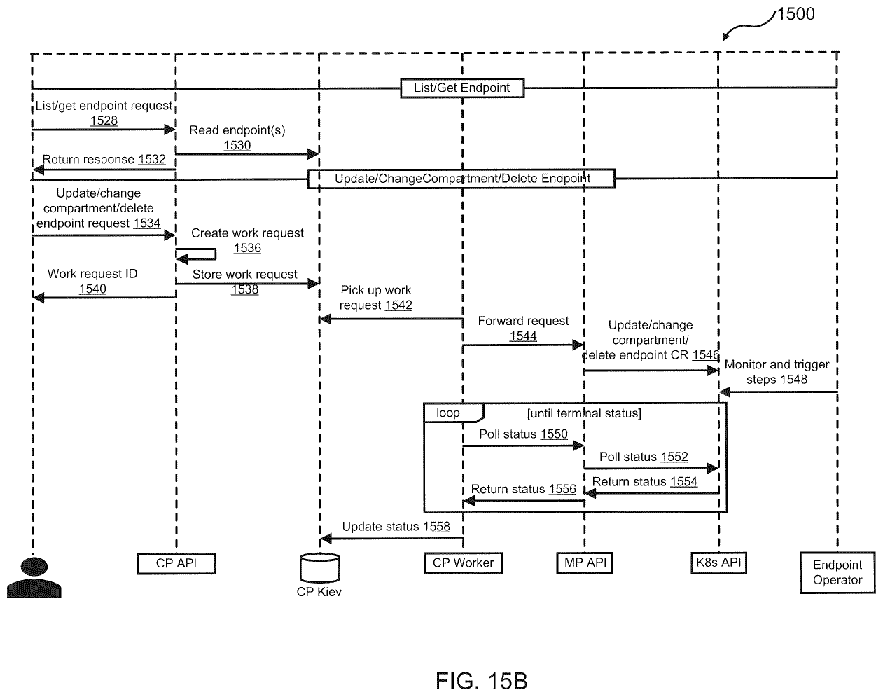

FIGS. 15A and 15B illustrate a sequence diagram 1500 of the process of creation of DACs, according to an exemplary embodiment. The process may be sequentially followed by various modules such as, a CP API server, a CP Kiev, a CP worker, an MP API server, a K8s API server, and an endpoint operator. The CP API server receives an endpoint request for creating an endpoint, at step 1502. The endpoint request includes a client ID of the client. In some embodiments, the DAC request may correspond to allocating computation capacity or increasing the computation capacity. The computation capacity corresponds to the amount of GPU resources available for the client.

In response to the request, the CP API server creates a work request for creating the endpoint and associates a work request with the client ID, at step 1504. Metadata for creating the endpoint (endpoint metadata) is provided to the CP API server via the request. The endpoint metadata may indicate a tenancy, a compartment, and a capacity reserved for the endpoint.

The CP API server stores the work request and the endpoint metadata in CP Kiev, at step 1506. The work request ID and the endpoint metadata may be transmitted to the client, at step 1508.

At step 1510, the CP worker receives the endpoint creation work request from the CP Kiev. The CP worker forwards the request to the MP API server, at step 1512.

In response to the request, the MP API server creates endpoint control request, at step 1514. The endpoint control request may indicate a number of GPU resources of the operation requested by the client. The MP API server stores the request and the endpoint metadata in Kubernetes custom resource in the data plane using the endpoint control request.

At step 1516, the DAC operator triggers the creation of endpoint using the Kubernetes custom resource in the data plane and monitors the endpoint being created by the Kubernetes operators. In such steps, the Kubernetes custom resource triggers the endpoint operator to collect the data related to each GPU resources available for clustering. The endpoint operators compare the collected data with the endpoint metadata to identify the GPU resources for clustering. The identified GPU resources are patched together to form the endpoint.

At step 1518, the CP worker requests the poll status of the work request to MP API server. The MP API server forwards the request of the poll status of the work request to the Kubernetes operator, at step 1520. At step 1522, the Kubernetes operator returns the poll status of the work request to the MP API server. The poll status may be further forwarded to the CP worker, at step 1524. The poll status may be updated in the CP Kiev, at step 1526.

At step 1528, the CP API server receives a request to list/get endpoint request. The request may correspond to operations, such as list: for listing the AI models available within the generative AI platform and get: for return an AI model. The CP API server reads or writes the endpoint metadata stored in CP kiev, at step 1530.

At step 1532, the CP API server transmits a response to the client. The response includes one of lists the AI models available within the generative AI platform, return an AI model corresponding to a model ID derived from the request metadata or change the owning compartment of the AI model whose model ID is provided by the client in request metadata.

At step 1534, the CP API server receives a request for updating/deleting the endpoint. The CP API server creates a work request for creating or deleting the endpoint and associates the work request with the client system 104 ID, at step 1536. Metadata for creating the endpoint (endpoint metadata) is provided to the CP API server via the request. The endpoint metadata may indicate the type of operation the client wants to perform on the endpoint, the amount of time for endpoint requirement, and other information related to lifecycle and management of the endpoint.

The CP API server stores the work request and DAC metadata in control plane Kiev, at step 1538. The work request ID and the endpoint metadata may be transmitted to the client, at step 1540.

At step 1542, the CP worker picks up the endpoint update/change work request from CP API server. The CP worker forwards the request to the management plane API, at step 1544.

In response to the request, the MP API creates endpoint control request, at step 1546. The MP API server stores the request metadata and the endpoint metadata in Kubernetes custom resource in the data plane using endpoint control request.

At step 1548, the endpoint operator triggers the update/change of endpoint using the Kubernetes custom resource in the data plane and monitors the endpoint being created by the Kubernetes operators. In such steps, the Kubernetes custom resource triggers the endpoint operator to collect the data related to each GPU resources patched into the endpoint. The endpoint operator updates/changes the DAC based on the request.

At step 1550, the CP worker requests the poll status of the work request to MP API server. The MP API server forwards the request of the poll status of the work request to the Kubernetes operator, at step 1552. At step 1554, the Kubernetes operator returns the poll status of the work request to the MP API server. The poll status may be further forwarded to the CP worker, at step 1556. The poll status may be updated in the CP Kiev, at step 1558.

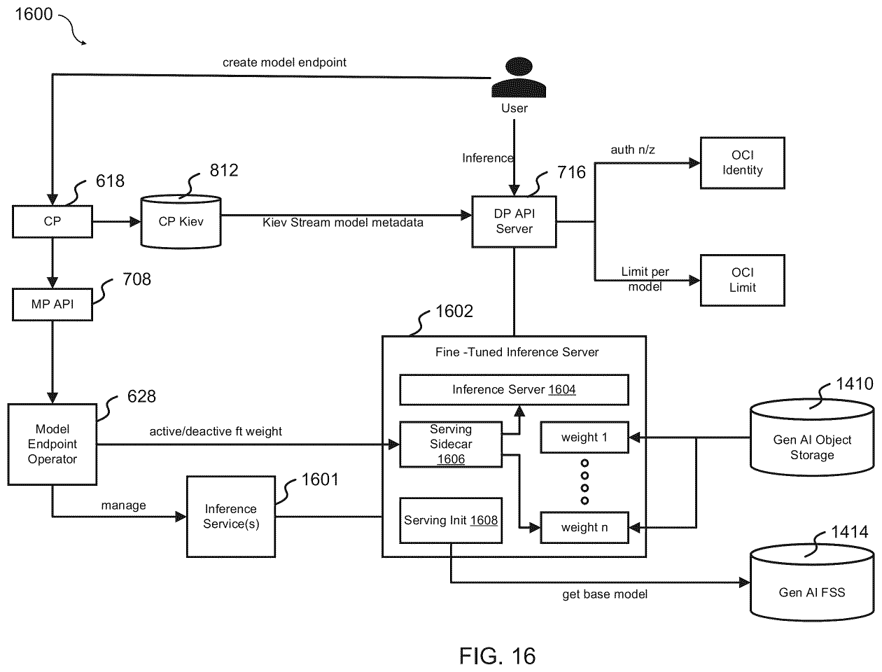

FIG. 16 illustrates a data flow diagram 1600 for managing an entire lifecycle of a fine-tuned inference server 210 using the model endpoint operator 628, according to an exemplary embodiment. Dedicated model inference endpoints provide the ability to perform inference on their pretrained or fine-tuned models with predictable latency and throughput. Each deployed dedicated model (fine-tuned or pretrained) is hosted in a Dedicated AI Cluster (DAC) and replicated across all GPU resources in the DAC. Preferably, the DAC can serve one base model with up to 50 instances of fine-tuned weights serve one base model with up to 50 instances of fine-tuned weights. Model endpoint metadata is synchronized from CP Kiev 806 to an internal cache memory of the generative AI data plane 202 for authorization of the request, routing, and rate limiting.

In operation, the GenAI CP 618 receives input(s) (such as request(s)) for creating model endpoint(s) from the client. Parallelly, the data plane API server 716 receives inference inputs from the client. Based on the received inputs, the GenAI CP 618 enables the CP Kiev 806 to provide Kiev stream model metadata to the data plane API server 716. Based on the inputs received by the data plane API server 716 from the client and the Kiev stream model metadata received from the CP Kiev 806, the data plane API server 716 generates a service module identity (i.e., OCI identity for authorization of the request) and a service module limit (i.e., OCI computation limit per model). The model endpoint operator 628 is coupled to the GenAI CP 618 by way of the MP API server 708. The model endpoint operator 628 manages inference service(s) 1601 for activation/deactivation of fine-tuning weight(s). Based on the received input(s) for creating model endpoints, the model endpoint operator 628, using the inference service(s) alters model weights for an inference server 1602. The inference server 1602 is further coupled with the data plane API server 716 and receives the inference inputs from the data plane API server 716. In some aspects of the present disclosure, the inference server 1602 includes an inference server 1604 supporting a serving sidecar 1606 and a serving initiator 1608. The serving sidecar 1606 receives instruction(s) for activation/deactivation of fine-tuning weight(s) from the model endpoint operator 628. The serving initiator 1608 receives a base model from the GenAI FSS 1414. The serving sidecar 1606 retrieves fine-tuned weights from the GenAI object storage 1410 and alters fine-tuned weight(s) for the base model for multiple instances based on the received instruction(s).

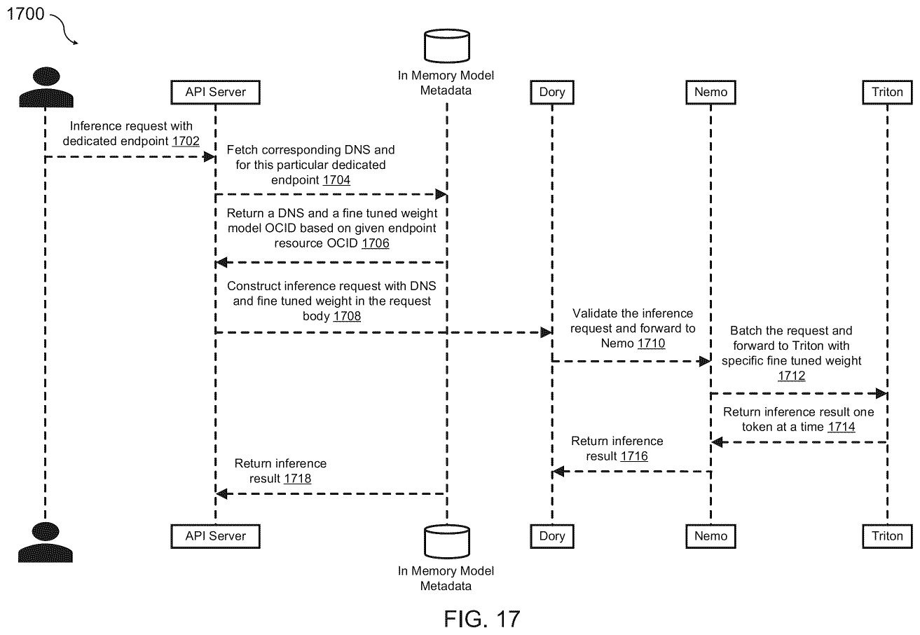

FIG. 17 illustrates a sequence diagram of a logical process 1700 within the inference server 1602, according to an exemplary embodiment. Process 1700 includes sequential steps between the data plane API server 716 and the inference server 1604. Process steps corresponding to the inference server 1604 includes operations of a Dori module, a Nemo module, and a Triton module.

The process 1700 begins at step 1702, when the data plane API server 716 receives an inference request with dedicated endpoint(s) from the client.

At step 1704, the data plane API server 716 generates a request to fetch a Domain Name System (DNS) corresponding to the request with dedicated endpoint(s) from the model metadata from an internal memory (hereinafter interchangeably referred to as ‘in-memory’).

At step 1706, in response to the request to fetch the DNS, the in-memory transmits the corresponding DNS along with a cloud identifier (e.g., Oracle Cloud Identifier) associated with the dedicated endpoint(s) to the data plane API server 716.

At step 1708 the data plane API server 716 constructs inference request based on the DNS and an Identifier for the fine-tuned weights (fine-tune ID) to the inference server 1604.

At steps 1710-1718, the inference server 1604 (through Dory) receives the inference request and determines validity of the inference request. Upon validation of the inference request, Dory routes the traffic corresponding to a particular fine-tune weight. Preferably, at step 1710, Dori transmits the inference request to Nemo for further processing. In response, at step 1712, Nemo batches the inference request and forwards it to Triton. Based on the inference request, at step 1714 Turion returns an inference return token to Nemo. Based on the received token, Nemo returns inference results to Dori at step 1716, which forwards them to the DP API server 716 at step 1718.

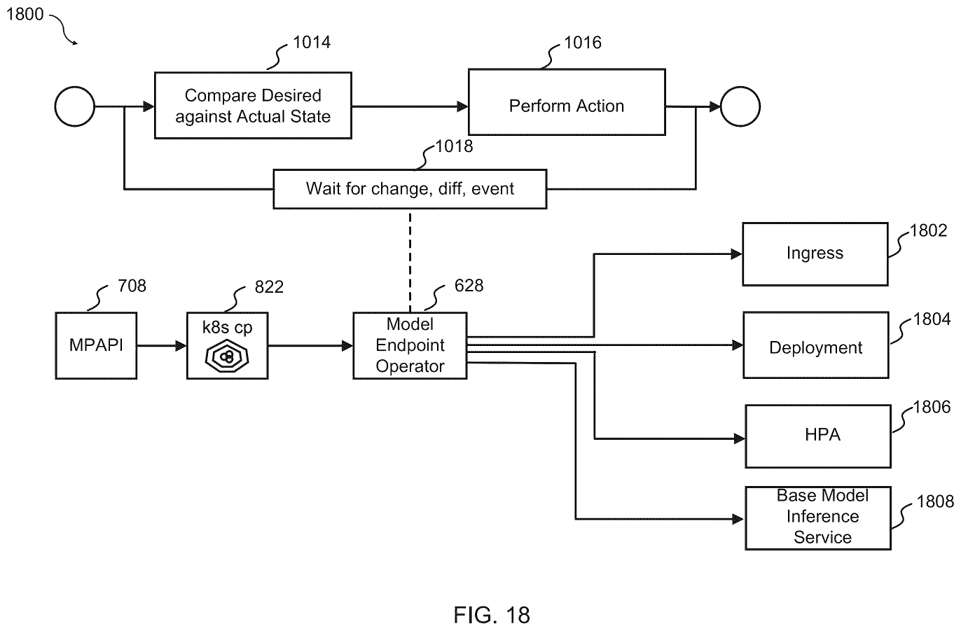

FIG. 18 illustrates a flow diagram 1800 indicating the working of a model endpoint operator, according to an exemplary embodiment. The model endpoint operator 628 manages a life cycle of service endpoints and continues to reconcile the service endpoint. Typically, the inference service endpoints are specific to either a base model or a fine-tuned model. For the base model endpoints, the model endpoint operator 628 reconciles low-native k8s resources such as ingress 1802, deployment 1804, HPA (horizontal pod autoscaler) 1806, and base model inference service. For fine-tuned model endpoints, the model endpoint operator 628 reconciles resources associated with base-model endpoint. Moreover, the model endpoint operator 628 reconciles a state of the fine-tuned model weight. The serving sidecar 1606 receives traffic associated with a status of the fine-tuned weights from the model endpoint operator. When the model weight does not exist, the model endpoint operator 628 triggers the serving sidecar 1606 to fetch the fine-tuned weight(s) spanned across the inference server 1604.

The DAC operator further makes updates to DACs such compartment changes based on the DAC metadata. The DAC operator performs CRUD operation and updates the DACs. These operations provide a state of the DAC to the client. For example, a state may be compared with an actual state in block 1014. Based on the comparison, the action is performed at block 1016. The operation is kept on hold till any difference or change in event is detected at block 1018.

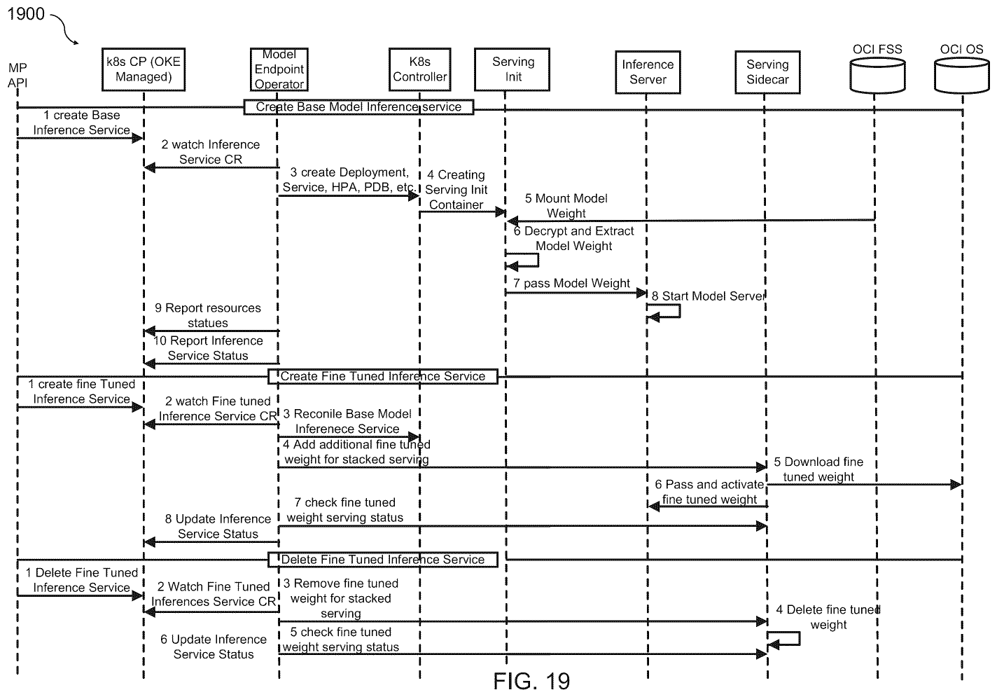

An embodiment for creating the base inference service, the fine-tuned inference service, and deleting the fine-tuning inference service is presented through a sequence diagram 1900 in FIG. 19.

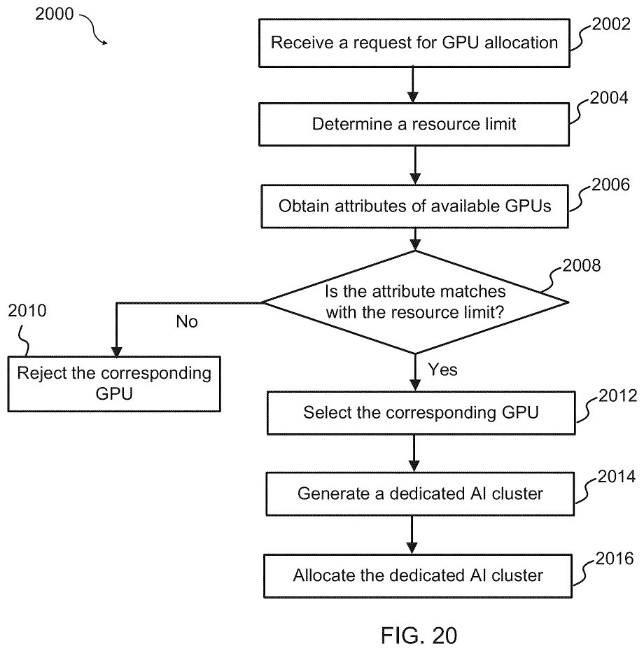

FIG. 20 illustrates a flowchart of a process 2000 for allocating a dedicated AI cluster, according to an exemplary embodiment. At block 2002, a request for GPU resource allocation is received from a client system associated with a client. The request may be received by a computing system. In some embodiments, the request may be related to execution of an operation. The request includes metadata identifying a client ID associated with the client, a throughput and a latency of the operation. The request is authenticated using the client ID associated with the client and/or the client system. The client ID may be associated with Hypertext Transfer Protocol (HTTP) signature which is used for authentication of the request. The process of the authentication involves signing a header of the HTTP signature using a private key extracted from an asymmetric key pair.

In some embodiments, the computing system may acquire a pre-approved quota associated with the request. If the pre-approved quota exceeds a pre-defined request limit corresponding to the client ID, the request may be blocked. If the pre-approved quota is within the pre-defined request limit, the request may be forwarded for further processing.

At block 2004, a resource limit for performing the operation is determined based on the metadata, when the request is authenticated using the metadata. For determining the resource limit, the metadata may be analyzed to determine a scope of the operation. The scope indicates computations to be executed for performing the operation. The scope of the operation is utilized to determine the resource limit for performing the operation. The resource limit indicates computational capacity for performing the operation.

Further, the computing system identifies GPU resources available for assignment. Each GPU resource has attributes indicating capacity of corresponding GPU resource. At block 2006, the attributes of the GPU resources are obtained for analysis. Further, the attributes of the GPU resources are analyzed with respect to the resource limit to determine a set of GPU resources for performing the operation. For example, the attributes of the GPU resources may be compared with the resource limit. At block 2008, if the attributes of GPU resources are not matched with the resource limit, the corresponding GPU resource may be rejected, at block 2010. If the attributes of GPU resources are matched with the resource limit, the corresponding GPU resource may be selected, at block 2012.

The GPU resources selected for allocation may be combined and patched together to form a dedicated AI cluster, at block 2014. The dedicated AI cluster reserves a portion of a computation capacity of the computing system for a period of time. In some embodiments, a type of operation may be determined based on the request. Further, the set of GPU resources is selected from one of a single node or multiple nodes, to generate the dedicated AI cluster. For example, if the request is related to fine-tuning of a data model, the set of GPU resources are selected from the single node to form the dedicated AI cluster. In such a case, a data model to be fine-tuned is obtained and a fine-tuning logic is executed on the data model using the dedicated AI cluster.

At block 2016, the dedicated AI cluster is assigned to the client. Once the dedicated AI cluster is assigned to the client and/or the client system associated with the client, the operation requested by the client starts performing using the GPU resources patched into the dedicated AI cluster. Assigning the dedicated AI cluster to the client ensures that workloads associated with the operation requested by the client are not mixed and matched with workload associated with an operation requested by another client. As a result, the computing system is able to provide the computation capacity for the operation which requires massive computational capacity, such as training or fine-tuning of the data model.

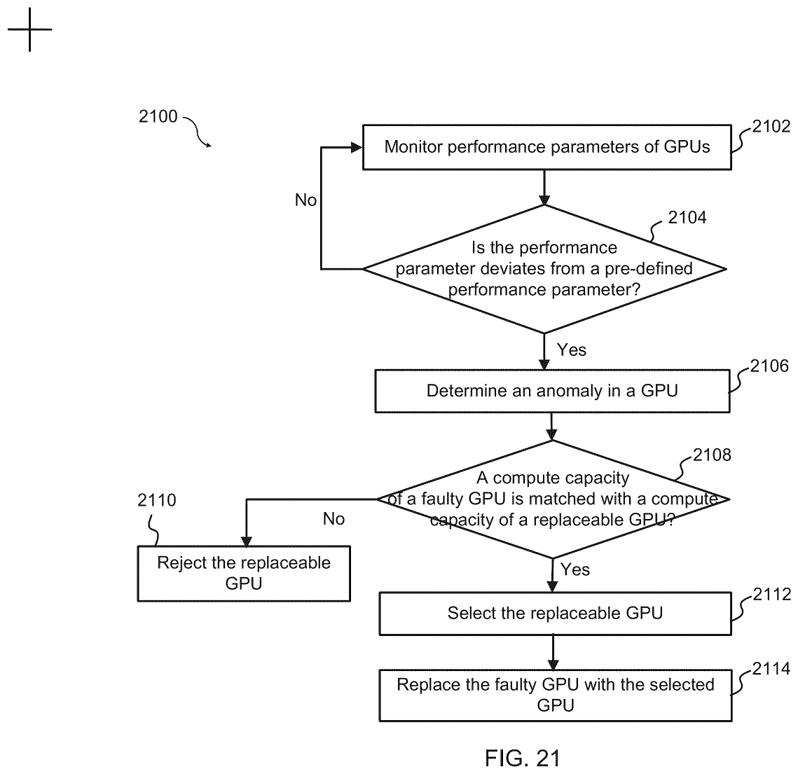

FIG. 21 illustrates a flowchart of a process 2100 of fault management, according to an exemplary embodiment. At block 2102, performance parameters of GPU resources are monitored. The performance parameters include a physical condition and/or a logical condition of a corresponding GPU resource. In an implementation, the physical condition of each GPU includes a temperature of corresponding GPU resource, a clock cycle of each core associated with the corresponding GPU resource, an internal memory of the corresponding GPU resource, and/or a power supply of the corresponding GPU resource. The logical condition of each GPU resource includes a failure of a plugin associated with corresponding GPU resource, a startup issue associated with the corresponding GPU resource, a runtime failure, and/or a security breach. The performance parameters corresponding to each GPU resource may be compared with pre-defined performance parameters. The pre-defined performance parameters indicate performance parameters of an ideal GPU resource. In some embodiments, the pre-defined performance parameters may be a range of values within which the GPU resource is considered as a GPU resource without a fault.

At block 2104, if the performance parameter does not deviate from the pre-defined performance parameter, the flow of the process 2100 is moved to block 2102 and the performance parameters of GPU resources may be monitored continuously. If the performance parameter deviates from the pre-defined performance parameter, an anomaly in a GPU resource of the set of GPU resources may be determined, at block 2106. When the anomaly is detected in the GPU resource, a replaceable GPU resource is identified from remaining GPU resources available in the computing system. For identifying replaceable GPU resource, a computation capacity of a faulty GPU resource may be matched with a computation capacity of the replaceable GPU resource, at block 2108.

If the computation capacity of the replaceable GPU resource is not matched with the computation capacity of the faulty GPU resource, the corresponding GPU resource may be rejected for replacement, at step 2110. If the computation capacity of the replaceable GPU resource is matched with the computation capacity of the faulty GPU resource, the replaceable GPU resource may be selected for replacement, at step 2112. The replaceable GPU resource is identified by matching the computation capacity of the replaceable GPU resource with the computation capacity of each GPU resource of the dedicated AI cluster. For example, a rotation hash value may be calculated for the replaceable GPU resource. The rotation value is calculated based on a computation image and/or a computation shape. The rotation hash value indicates security and compliance status of corresponding GPU resource. The rotation value of the replaceable GPU resource is further compared with a rotation hash value of the dedicated AI cluster. When the rotation value of the replaceable GPU resource is matched with the rotation value of the dedicated AI cluster, the replaceable GPU resource may be selected for replacement of the failed GPU resource. Post identification, the failed GPU resource is released from the dedicated AI cluster and the replaceable GPU resource is patched to the dedicated AI cluster, at step 2114. In such a way, a set of replaceable GPU resources may be reserved for replacement of a failed GPU resource of the dedicated AI cluster.

During patching of the replaceable GPU resource to the dedicated AI cluster may be terminated when a pre-defined condition is determined. The pre-defined condition is a failure of the replaceable GPU resource during launch, a failure of the replaceable GPU resource to join the dedicated AI cluster, a workload failure of the replaceable GPU resource, and/or a software bug detected in the replaceable GPU resource. In case of determination of the pre-defined condition, a tag may be associated with the replaceable GPU resource. The tag indicates unsuitability in patching of the replaceable set of GPU resources.

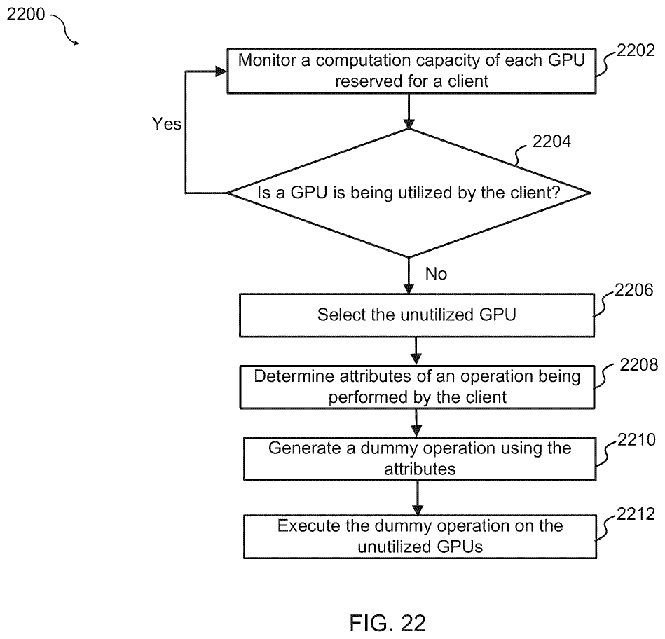

FIG. 22 illustrates a flowchart of a process 2200 for managing execution of operations using the GPU resources, according to an exemplary embodiment. At block 2202, computation capacities of GPU resources are monitored. The GPU resources are reserved for the client for a period of time. During the period of time, the operation may not consume all the computation capacity reserved for the client. In such a case, some of the GPU resources from the set of GPU resources are not utilized for performing the operation requested by the client.

At block 2204, it is determined that a GPU resource of the set of GPU resources is utilized by the client or not. If it is utilized by the client, the process 2100 is moved to block 22022 and monitoring of the computation capacity of the set of GPU resources continues. If the GPU resource is not utilized by the client, the unutilized GPU resource is selected, at block 2206.

At block 2208, attributes of the operation being performed by the client may be determined. The attributes are determined based on an analysis of an input and an output of the operation. At block 2210, a dummy operation is generated based on the attributes. For example, attributes of the dummy operation match with the attributes of the dummy operation, at block 2212. In some embodiments, the dummy operation may be the same operation (e.g., exactly the same operation) as an actual operation performed by the client. The dummy operation is executed on the GPU resources that are not utilized by the client.

In case the computing system receives a request to access the GPU resources for performing the operation, the dummy operation may be terminated from the execution of the dummy operation and may be patched for the actual operation requested by the client. Thus, the time to load the GPU resource from idle condition is mitigated. As a result, the latency of the overall process of the operation is enhanced.

Some embodiments of the present disclosure include a system including one or more data processors. In some embodiments, the system includes a non-transitory computer readable storage medium containing instruction which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and described or portions thereof, but it is recognized that various modifications are possible within the scope of the invention claimed. Thus, although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments, and is not intended to limit the scope, applicability or configuration of the disclosure. The present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

1. A computer-implemented method comprising:
receiving a request for allocating graphical processing unit (GPU) resources for performing an operation, wherein the request includes metadata identifying a client identifier (ID) associated with a client, a target throughput and a target latency of the operation;
determining a resource limit for performing the operation based on the metadata;
obtaining at least one attribute associated with each GPU resource of a plurality of GPU resources available for assignment in a computing system, wherein the at least one attribute indicates capacity of a corresponding GPU resource;
analyzing the at least one attribute associated with each GPU resource with respect to the resource limit;
identifying a set of GPU resources from the plurality of GPU resources based on the analysis;
generating a dedicated AI cluster by patching the set of GPU resources within a single cluster, wherein the dedicated AI cluster reserves a portion of a computation capacity of the computing system for a period of time; and
allocating the dedicated AI cluster to the client associated with the client ID.

2. The method of claim 1, further comprising authenticating, prior to the allocation of the dedicated AI cluster, the request based on the client ID associated with the client, wherein the request is authenticated using a private key extracted from an asymmetric key pair associated with the client ID.

3. The method of claim 1, further comprising:
comparing a set of performance parameters corresponding to each GPU resource of the set of GPU resources with a pre-defined set of performance parameters;
determining an anomaly in a first GPU resource of the set of GPU resources based on the comparison, wherein the anomaly indicates a deviation in the set of performance parameters from the pre-defined set of performance parameters; and
replacing the first GPU resource with a second GPU resource within the dedicated AI cluster, wherein a hash value of the second GPU resource is the same as a hash value of the first GPU resource.

4. The method of claim 1, further comprising:
determining a pre-approved quota associated with the request;
determining whether the pre-approved quota exceeds a pre-defined request limit corresponding to the client ID; and
blocking the request based on the determination that the pre-approved quota exceeds the pre-defined request limit.

5. The method of claim 1, further comprising:
determining a type of the operation based on the request; and
selecting, based on the type of the operation, the set of GPU resources from one of a single node or multiple nodes, to generate the dedicated AI cluster.

6. The method of claim 5, further comprising, based on determining that the request indicates a fine-tuning operation:
obtaining a data model to be fine-tuned; and
executing a fine-tuning logic on the data model using the dedicated AI cluster, wherein the dedicated AI cluster is generated using the set of GPU resources selected from the single node.

7. The method of claim 1, further comprising:
identifying at least one GPU resource, from the set of GPU resources of the dedicated AI cluster, that is underutilized; and
executing, in response to the identification of the at least one GPU resource, a dummy operation on the at least one GPU resource, wherein the dummy operation is exactly the same as the operation performed on the at least one GPU resource.

8. A system comprising:
one or more processors; and
a memory coupled to the one or more processors, the memory storing a plurality of instructions, executable by the one or more processors, which, when executed by the one or more processors cause the one or more processors to perform a set of operations comprising:
receiving a request for allocating graphical processing unit (GPU) resource for performing an operation, wherein the request includes metadata identifying a client identifier (ID) associated with a client, a throughput and a latency of the operation;
determining a resource limit for performing the operation based on the metadata;
obtaining at least one attribute associated with each GPU resource of a plurality of GPU resources available for assignment in the system, wherein the at least one attribute indicates capacity of a corresponding GPU resource;
analyzing the at least one attribute associated with each GPU resource with respect to the resource limit;
identifying a set of GPU resources from the plurality of GPU resources based on the analysis;
generating a dedicated AI cluster by patching the set of GPU resources within a single cluster, wherein the dedicated AI cluster reserves a portion of a computation capacity of a computing system for a period of time; and
allocating the dedicated AI cluster to the client associated with the client ID.

9. The system of claim 8, wherein the set of operations further includes: authenticating, prior to the allocation of the dedicated AI cluster, the request based on the client ID associated with the client, wherein the request is authenticated using a private key extracted from an asymmetric key pair associated with the client ID.

10. The system of claim 8, wherein the set of operations further includes:
comparing a set of performance parameters corresponding to each GPU resource of the set of GPU resources with a pre-defined set of performance parameters;
determining an anomaly in a first GPU resource of the set of GPU resources based on the comparison, wherein the anomaly indicates a deviation in the set of performance parameters from the pre-defined set of performance parameters; and
replacing the first GPU resource with a second GPU resource within the dedicated AI cluster, wherein a hash value of the second GPU resource is the same as a hash value of the first GPU resource.

11. The system of claim 8, wherein the set of operations further includes:
determining a pre-approved quota associated with the request;
determining whether the pre-approved quota exceeds a pre-defined request limit corresponding to the client ID; and
blocking the request based on the determination that the pre-approved quota exceeds the pre-defined request limit.

12. The system of claim 8, wherein the set of operations further includes:
determining a type of the operation based on the request; and
selecting, based on the type of the operation, the set of GPU resources from one of a single node or multiple nodes, to generate the dedicated AI cluster.

13. The system of claim 12, wherein the set of operations further includes based on determining that the request indicates a fine-tuning operation:
obtaining a data model to be fine-tuned when the request indicates a fine-tuning operation; and
executing a fine-tuning logic on the data model using the dedicated AI cluster, wherein the dedicated AI cluster is generated using the set of GPU resources selected from the single node.

14. The system of claim 8, wherein the set of operations further includes:
identifying at least one GPU resource from the set of GPU resources of the dedicated AI cluster that is underutilized; and
executing, in response to the identification of the at least one GPU resource, a dummy operation on the at least one GPU resource, wherein the dummy operation is exactly the same as the operation performed on the at least one GPU resource.

15. A non-transitory computer-readable medium storing a plurality of instructions executable by one or more processors to cause the one or more processors to perform a set of operations comprising:
receiving a request for allocating graphical processing unit (GPU) resource for performing an operation, wherein the request includes metadata identifying a client identifier (ID) associated with a client, a throughput and a latency of the operation;
determining a resource limit for performing the operation based on the metadata;
obtaining at least one attribute associated with each GPU resource of a plurality of GPU resources available for assignment in a computing system, wherein the at least one attribute indicates capacity of a corresponding GPU resource;
analyzing the at least one attribute associated with each GPU resource with respect to the resource limit;
identifying a set of GPU resources from the plurality of GPU resources based on the analysis;
generating a dedicated AI cluster by patching the set of GPU resources within a single cluster, wherein the dedicated AI cluster reserves a portion of a computation capacity of a computing system for a period of time; and
allocating the dedicated AI cluster to the client associated with the client ID.

16. The non-transitory computer-readable medium of claim 15, wherein the set of operations further comprises authenticating, prior to the allocation of the dedicated AI cluster, the request based on the client ID associated with the client, wherein the request is authenticated using a private key extracted from an asymmetric key pair associated with the client ID.

17. The non-transitory computer-readable medium of claim 15, wherein the set of operations further comprises:
comparing a set of performance parameters corresponding to each GPU resource of the set of GPU resources with a pre-defined set of performance parameters;
determining an anomaly in a first GPU resource of the set of GPU resources based on the comparison, wherein the anomaly indicates a deviation in the set of performance parameters from the pre-defined set of performance parameters; and
replacing the first GPU resource with a second GPU resource within the dedicated AI cluster, wherein a hash value of the second GPU resource is exactly the same as a hash value of the first GPU resource.

18. The non-transitory computer-readable medium of claim 15, wherein the set of operations further comprises:
determining a pre-approved quota associated with the request;
determining whether the pre-approved quota exceeds a pre-defined request limit corresponding to the client ID; and
blocking the request based on the determination that the pre-approved quota exceeds the pre-defined request limit.

19. The non-transitory computer-readable medium of claim 15, wherein the set of operations further comprises:
determining a type of the operation based on the request; and
selecting, based on the type of the operation, the set of GPU resources from one of a single node or multiple nodes, to generate the dedicated AI cluster.

20. The non-transitory computer-readable medium of claim 15, wherein the set of operations further comprises:
identifying at least one GPU resource from the set of GPU resources of the dedicated AI cluster that is underutilized; and
executing, in response to the identification of the at least one GPU resource, a dummy operation on the at least one GPU resource, wherein the dummy operation is exactly same as the operation performed on the at least one GPU resource.
